(19) United States
(12) Patent Application Publication
(10) Pub. No.: US 2013/0073323 A1
(43) Pub. Date: Mar. 21, 2013

(54) TRAVEL EXPLORATION METHODS AND APPARATUS

(71) Applicants: Giorgos C. Zacharia, Winchester, MA (US); Paul M. English, Winchester, MA (US); Lincoln D. Jackson, Newburyport, MA (US); Jeff A. Rago, Lexington, MA (US); Adam Baratz, Cambridge, MA (US); Sidra Michon, Lexington, MA (US)

(72) Inventors: Giorgos C. Zacharia, Winchester, MA (US); Paul M. English, Winchester, MA (US); Lincoln D. Jackson, Newburyport, MA (US); Jeff A. Rago, Lexington, MA (US); Adam Baratz, Cambridge, MA (US); Sidra Michon, Lexington, MA (US)

(73) Assignee: Kayak Software Corporation, Norwalk, CT (US)

(21) Appl. No.: 13/453,504

(22) Filed: Apr. 23, 2012

Related U.S. Application Data
(60) Provisional application No. 61/478,389, filed on Apr. 22, 2011.

(51) Int. Cl. G06Q 10/02

(52) U.S. Cl. 705/5

(57) ABSTRACT

In one aspect, a computer system comprising at least one computer storing a software implemented exploration tool is provided. The exploration tool, when processed by the at least one computer, performs a method comprising providing at least one first interface for display to a user, the at least one first interface allowing the user to provide criteria regarding a trip, receiving, via the at least one first interface, at least one criterion from the user indicating one or more travel preferences, the at least one criterion not including a specific destination, obtaining travel results for a plurality of destinations, each of the travel results meeting the at least one criterion, and providing the travel results for display to the user.

### RELATED APPLICATION

This application claims priority under 35 U.S.C. §119(e) to Provisional Application Ser. No. 61/478,389, entitled “Travel Exploration Methods and Apparatus,” filed Apr. 22, 2011, which is herein incorporated by reference in its entirety.

### BACKGROUND

People arranging travel or vacation plans often have one or more criteria that they would like met for the trip. For example, travelers may have budget constraints regarding how much they are willing to spend on a vacation. Travelers may also have time constraints or preferences that limit how long a flight they are willing or able to take, or a traveler may have a physical limitation that places restrictions on flight time. In addition, travel plans are often made in consideration of the availability of certain activities, or geographical preferences such as a desire for warm or cold weather, proximity to a beach, mountains, water, etc. A travel plan may have to meet one, multiple or all of a set of criteria in order for the user to consider the travel plan acceptable.

Conventionally, a traveler must utilize one or more search sites to individually obtain flight and/or hotel information on each destination that the user has identified as a candidate and which the user has specified to the search sites as a search query to determine whether available flights and/or hotels meet any further criteria that the user may require (e.g., budget, flight times, etc.). In attempting to narrow possible destinations from a substantial number of possibilities by providing different origin/destination pairs to the search sites, a large number of searches may be required, consuming a considerable amount of time and effort on the part of the user initiating search queries on a destination-by-destination basis.

### SUMMARY

Some embodiments include at least one computer readable storage medium storing instructions that, when executed by at least one computer, perform a method comprising receiving at least one criterion from a user indicating one or more travel preferences, the at least one criterion not including a specific destination, obtaining travel results for a plurality of destinations, each of the travel results meeting the at least one criterion, and providing the travel results for display to the user.

Some embodiments include a computer system comprising at least one computer storing a software implemented exploration tool that, when processed by the at least one computer, performs a method comprising providing at least one first interface for display to a user, the at least one first interface allowing the user to provide criteria regarding a trip receiving, via the at least one first interface, at least one criterion from the user indicating one or more travel preferences, the at least one criterion not including a specific destination, obtaining travel results for a plurality of destinations, each of the travel results meeting the at least one criterion, and providing the travel results for display to the user.

Some embodiments include a system comprising at least one storage medium for storing a flight cache comprising a plurality of flight results, at least one processor capable of accessing the at least one storage medium to access the flight cache, the at least one processor configured to receive at least one criterion from the user indicating one or more travel preferences, the at least one criterion not including a specific destination, obtain travel results for a plurality of destinations at least in part by querying the flight cache using the at least one criterion, wherein each of the travel results meet the at least one criterion, and provide the travel results for display on at least one user computer.

### BRIEF DESCRIPTION OF THE DRAWINGS

FIG. 1 illustrates a computer system on which embodiments of travel exploration described herein may be implemented;

FIG. 2 illustrates a method of exploring travel options, in accordance with some embodiments;

FIGS. 3A-3J illustrate examples of an exploration tool implementing various flight exploration techniques in accordance with some embodiments;

FIGS. 4A-4E illustrate examples of an exploration tool implementing various flight and hotel exploration techniques in accordance with some embodiments;

FIGS. 5A-5K illustrate further examples of an exploration tool implementing flight and hotel exploration techniques in accordance with some embodiments;

FIGS. 6A-6D illustrate using an exploration tool to explore a selected location in accordance with some embodiments;

FIGS. 7A-7F illustrate further examples of an exploration tool implementing flight and hotel exploration techniques in accordance with some embodiments; and

FIG. 8 illustrates an exemplary computer on which one or more embodiments described herein may be implemented.

### DETAILED DESCRIPTION

As discussed above, conventional travel planning often includes tedious and time consuming destination-by-destination searches on possible travel locations to check whether a potential destination meets one or more travel criteria or requirements of the user. This is partly because the onus of identifying candidate destinations falls on the traveler and partly because conventional search facilities require a destination to perform a query so that only single destinations can be queried at a time (e.g., conventional search facilities require a user to provide an origin/destination pair for which the search facility queries for available flights).

Such conventional travel planning may not only be frustrating and time consuming for the traveler, but such conventional travel planning has the additional drawbacks in that a traveler may overlook or fail to identify potential destinations that meet the user's needs, or the traveler may not have the time or patience to check each potential destination (e.g., by individually providing origin/destination pair queries for each destination that the traveler has identified as a candidate). As a result, travel planning can be very difficult and travelers may miss out on flights or other travel opportunities that the traveler was not aware of because they did not specifically query a particular destination.

The inventors have recognized that travelers may frequently consider taking a trip without having a specific destination in mind. In particular, a traveler may have some ideas about the nature of a trip, but may not have considered particular destinations that fit the bill. For example, a traveler may have an idea about how much money the traveler would like to spend, how long a flight the user is willing to take and how many stops are acceptable. Additionally, or alternatively, a user may have some ideas regarding activities for a trip (e.g., beach, golf, skiing, scuba diving, hiking, etc.), or may have some geographical preferences such as weather, geographic features (e.g., beach, mountains, etc.), cultural or food interests. Conventionally, there is no way to conveniently explore options aside from performing destination-by-destination searches for each destination specified by the user. As is often the case, a user may not even be aware of all of the destinations available that meet their trip criteria, making conventional approaches even less effective.

The inventors have developed an exploration tool that allows a user to input desired criteria for potential travel without having to specify a destination. The exploration tool may then perform a search using the specified criteria and present results associated with multiple destinations that meet the criteria input by the user. For example, the exploration tool may locate all destinations having flights that meet the user-specified criteria, and present the available flights/destinations to the user and/or the exploration tool may display hotel information for the destinations that meet the criteria. By providing travel results (e.g., flight information, hotel information, etc.) associated with multiple destinations that meet a given criteria, the user can avoid having to obtain travel information such as flight and/or hotel data for each potential destination on a destination-by-destination basis. As such, the user need not have any particular destination in mind and can use the exploration tool to identify candidate destinations instead of having to identify such destinations themselves beforehand and individually specify origin/destination pairs to the search facility.

In some embodiments, the exploration tool is a network based tool (e.g., a website) accessible by users. The exploration tool may receive, via an interface provided on the tool, at least one travel criterion that does not include a specific destination and present to the user travel results (e.g., flights/destinations and/or hotels) for a plurality of destination, each travel result meeting the user's at least one criterion. According to some embodiments, travel results are displayed in a list, with or without associated pricing information for travel information that has associated prices. In some embodiments, travel results meeting a user's selected criteria are displayed as an overlay on a map, with or without associated pricing information. In some embodiments, both list and map presentations are displayed to the user to present the results on flights/destinations and/or hotels that meet the criteria specified by the user. The different presentations may be used alone or in any combination to provide travel results associated with multiple destinations to the user. In some embodiments, travel results are presented for each destination that meets the criteria specified by the user. Travel results refer herein to information on flights, destinations and/or hotels obtained by performing a search using at least one criterion specified by a user.

The criteria provided by the user may be any type of parameter, requirement, preference or characteristic related to a trip. For example, criteria may include, but are not limited to, any one or combination of origin/departure location, price, flight time (e.g., duration of flight), flight itinerary (non-stop, one-stop, etc.), activities available at destination (e.g., golf, gambling, skiing, etc.), geography of a destination (temperature, proximity to beaches, mountains, etc.), region (continent, country, state, city, etc.), available travel dates, language of destination (e.g., English or French speaking destinations), hotel star rating, hotel price, accommodation type (e.g., hotel, inn, bed-and-breakfast, motel, resort, chain, etc.), or any other travel related criteria. The criteria may operate as a filter for all available destinations so that only destinations meeting the user's criteria are presented to the user, as discussed in further detail below and as shown pictorially in the drawings.

Following below are more detailed descriptions of various concepts related to, and embodiments of, methods and apparatus according to the present invention. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

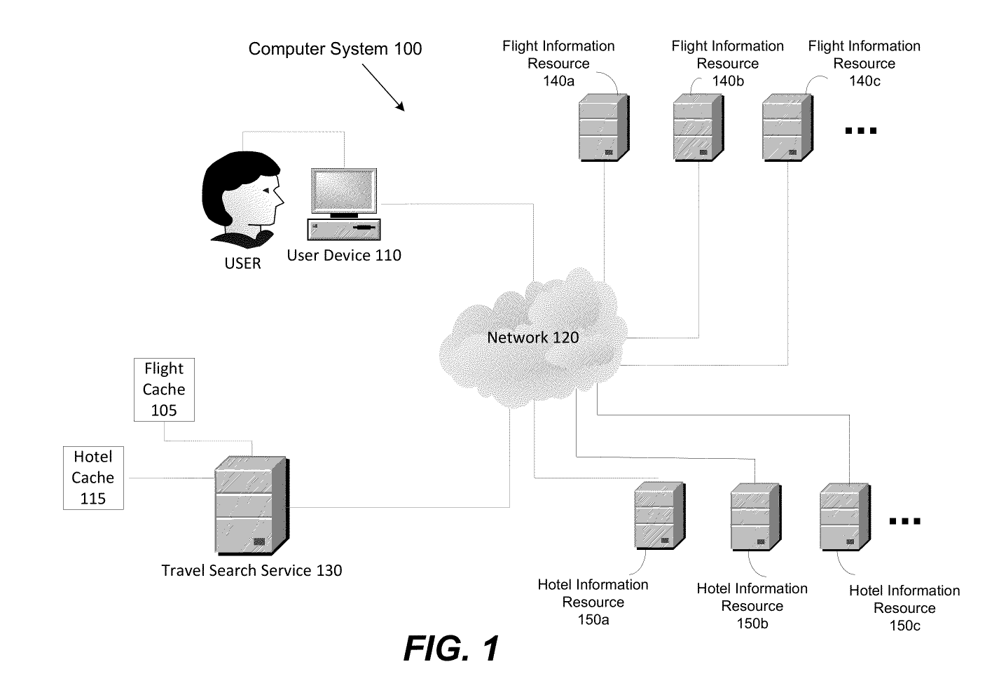

FIG. 1 illustrates a networked computer system on which aspects of the invention may be performed, and depicts a computer system by which a user may obtain travel results that meet a user's specified criteria. Computer system 100 includes one or more user devices 110. User device 110 may include one or any combination of personal computer, workstation, networked terminal, kiosk, personal digital assistant (PDA), smart phone or any other electronic device that allows a user to access network 120. Network 120 may include any one or combination of networks such as private networks, public networks, the Internet, or any combination of local area networks (LANS), wide area networks (WANs), etc. In general, user device 110 may be any device or combination of devices that allows a user to provide input (e.g., travel criteria) and receive travel results.

Computer system 100 also includes travel search service 130 configured to perform flight queries and/or hotel queries on behalf of a user. For example, a user may specify criteria regarding a potential trip and travel search service 130 may present to the user available flights/destinations that match the specified criteria. Travel search service 130 may also provide hotel information regarding hotels at desired locations independent of or in connection with a flight search. Travel search service 130 may include one or multiple computers, computer systems, servers, data storage devices, etc. Travel search service 130 may include data storage for storing a flight cache 105 and/or hotel cache 115 accessible by the one or more computers forming the travel search service 130. Travel search service 130 may implement an exploration tool in accordance with one or more embodiments described herein. For example, travel search service 130 may host a website that provides an exploration tool that the user can access via user device 110 and interact with to explore travel options.

Flight cache may be a local store of flight results that may be accessed to obtain flight results without having to actually query a flight information resource. For example, the flight cache 105 may be stored in memory as part of a database that can be queried by the one or more computers forming the travel search service 130, or otherwise stored such that it can be accessed to obtain flight information in response to user queries. Examples of flight cache generation and optimization are described in U.S. application Ser. No. 13/407,035, entitled “Flight Caching Methods and Apparatus” (“Flight Caching”), which is herein incorporated by reference in its entirety. Similarly, hotel cache 115 may be a local store of hotel availability and pricing information accessible by the travel search service 130 without having to query hotel information resources 150.

Travel search service 130 may be connected to network 120 and configured to communicate with the user device 110 and one or any combination of flight information resources 140 and hotel information resources 150. Travel search service 130 may be configured to query one or more of the different flight information resources connected to the network to obtain flight pricing and availability information. Similarly, travel search service 130 may be configured to query one or more of the different hotel information resources connected to the network to obtain hotel pricing and availability information. It should be appreciated that the number and type of resources illustrated is exemplary and any number of resources of any type may be connected to the network and made accessible to travel search service 130.

Travel search service 130 may use results obtained from the information resources to report results to a user, update one or more caches, or both. Travel search service 130 may be able to service user queries without accessing the flight information resources 140 or hotel information resources 150 and instead rely on flight cache 105 and/or hotel cache 115. Travel search service 130 may service some user queries using a combination of information resource and cache solutions. As discussed in further detail below, travel search service 130 may include one or more programs stored on a computer readable medium and executable by one or more processors available in or to the one or more computers forming the travel service provider. The one or more programs may be configured, when executed, to receive user input (e.g., travel criteria), perform queries, probe the cache, obtain travel results and present travel results to the user. Travel search service 130 may include an exploration tool that facilitates a user exploring travel options without having to specify a particular destination. For example, travel service 130 may host one or more websites implementing an exploration tool accessible by user device 110, some embodiments of which are discussed in further detail below.

User device 110 may include one or more displays on which travel results may be displayed. For example, user device 110 may include a display on which available flights/destinations that meet a given criteria, or a desired subset thereof, provided or presented by the travel search service 130 via an exploration tool are displayed to the user (e.g., as an overlay on a map, or via a different presentation technique that facilitates relatively intuitive understanding of the destination possibilities available to the user based on the user's travel criteria). Likewise, hotel information regarding one or more available destinations may also be displayed to the user via device 110. Various non-limiting presentation techniques are described in further detail below.

As discussed above, a user may be considering travel without a specific or fixed destination in mind. Instead, the user may have one or more different constraints or criteria regarding a trip. Conventionally, before exploring trip options, the traveler would have to identify a number of destinations and then perform searches, e.g., flight and hotel searches, individually for those destinations to make sure that any other constraints or criteria are met. The inventors have recognized that a different model may facilitate easier, more convenient and less tedious exploration of travel options when the user, for whatever reasons, is not restricted to a particular destination and/or would like to see what destinations are available given one or more other constraints, preferences or parameters concerning the trip. In this regard, the inventors have developed an exploration tool that allows a user to explore what destinations are available according to a given set of criteria that is open-ended with respect to destination.

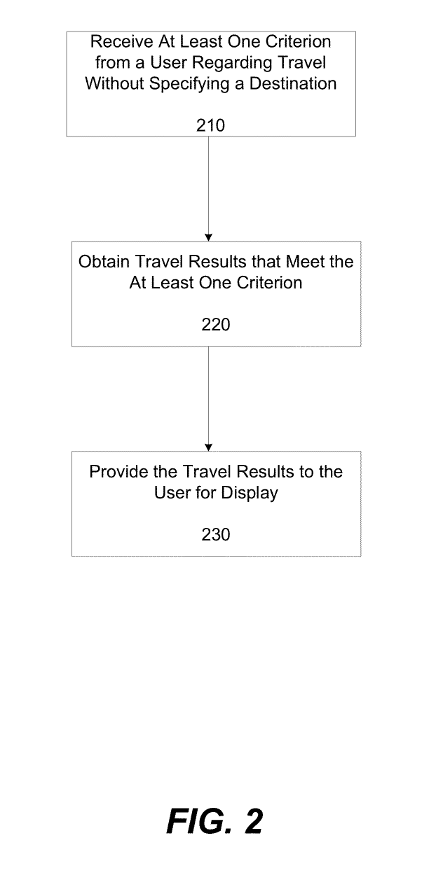

FIG. 2 illustrates a method for travel exploration implemented by an exploration tool according to some embodiments. For example, the exploration tool may be provided via a website or other online facility accessible by a user. In act 210, at least one criterion is received from the user corresponding to a potential trip. For example, the user may specify, via an interface or control of the exploration tool, one or more criteria regarding a trip that the user would like to explore. The one or more criteria may include any one or combination of constraints or preferences such as departure city, price, length of flight, number of stops, timeframe, activities, geographic preferences, etc. The user need not specify a destination but, in some embodiments, the user may specify a particular region or area, such as a country, continent or other region of interest that includes multiple destinations. However, the destination may be entirely open-ended and include no specific limitations on locale.

In act 220, the exploration tool obtains results that meet the one or more criterion provided by the user. For example, the one or more criteria may include an origin or departure city and the exploration tool may search on all flights departing from airports associated with the specified city. The exploration tool may obtain these flight results by querying one or more flight information resources to obtain flight results. Alternatively, or in addition to, the exploration tool may access a flight cache to obtain results that meet the one or more criteria. Additionally, for hotel results, the exploration tool may obtain results from one or more hotel information resources or may access a cache of hotel results regarding pricing and availability. The exploration tool may access any type or number of resources to compile a list of results that meet the one or more criteria provided by the user. If further criteria are specified, the travel results may be filtered according to this criteria. Alternatively, further criteria may be incorporated into the search query to obtain the travel results. The travel results meeting the at least one criterion may be obtained in any way, as the aspects of the invention are not limited to a particular manner of searching for and/or filtering travel results.

In act 330, the exploration tool presents travel results to the user. For example, the exploration tool may present available flights/destinations as an overlay on a map to show the user the available options and their locations. Hotel results may likewise be visualized by presenting such results on a map. In some embodiments, hotel results are displayed only after a user has indicated an interest in one or more of the presented destinations. Travel results may be presented to the user in any number of ways, some of which are described in further detail below. In some embodiments, the exploration tool is a web-based tool that can be accessed by the user over the Internet. In such embodiments, the travel results may thus be presented as an interactive web page, as discussed in further detail below.

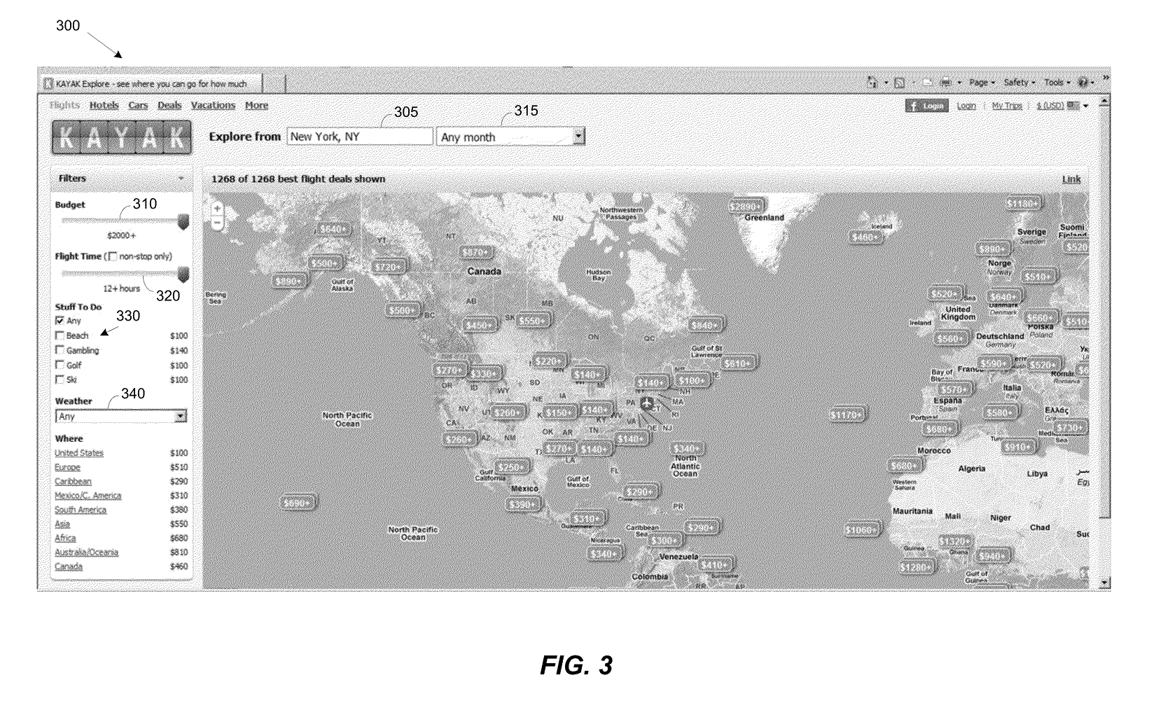

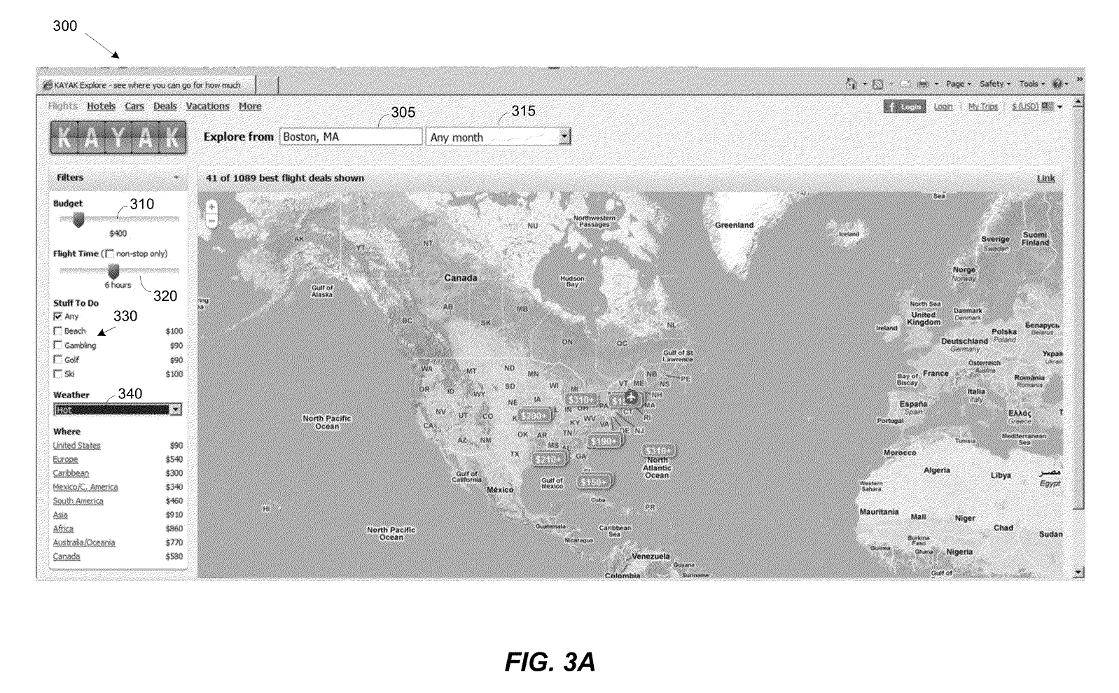

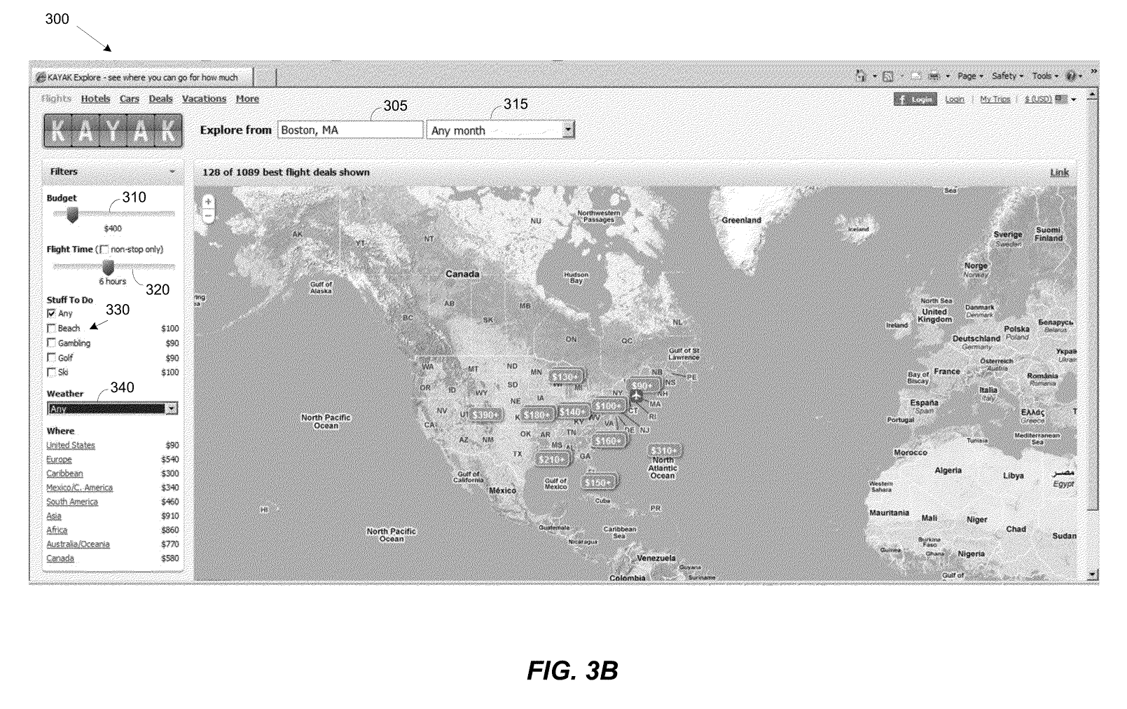

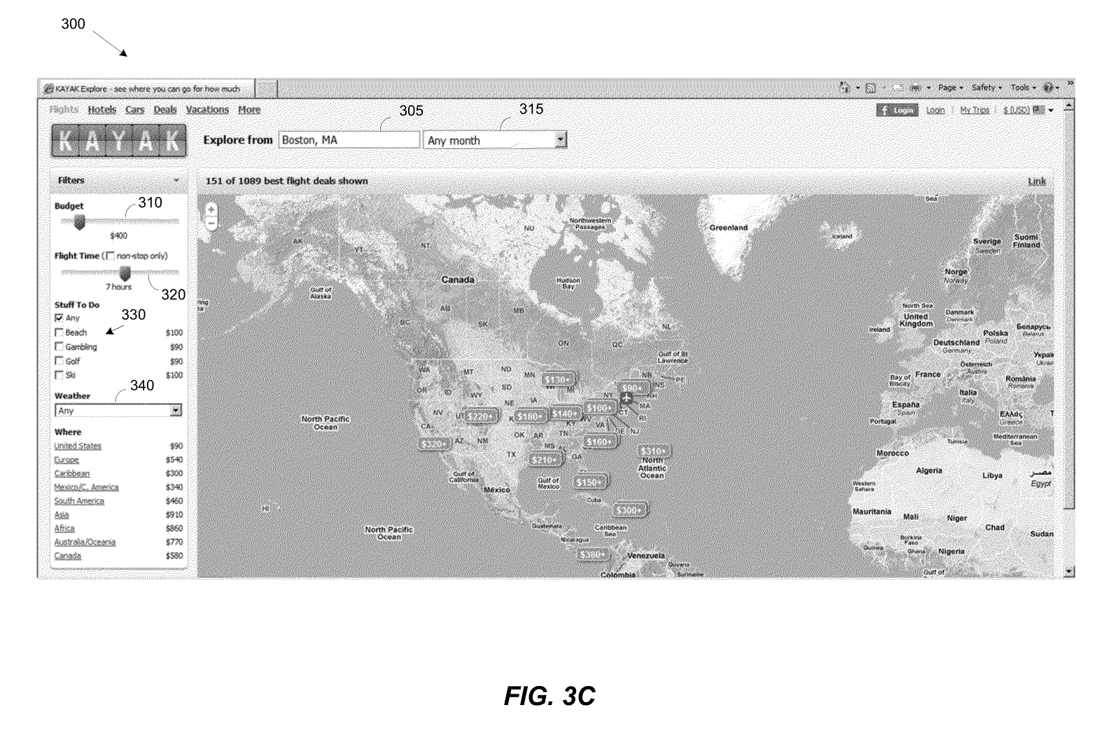

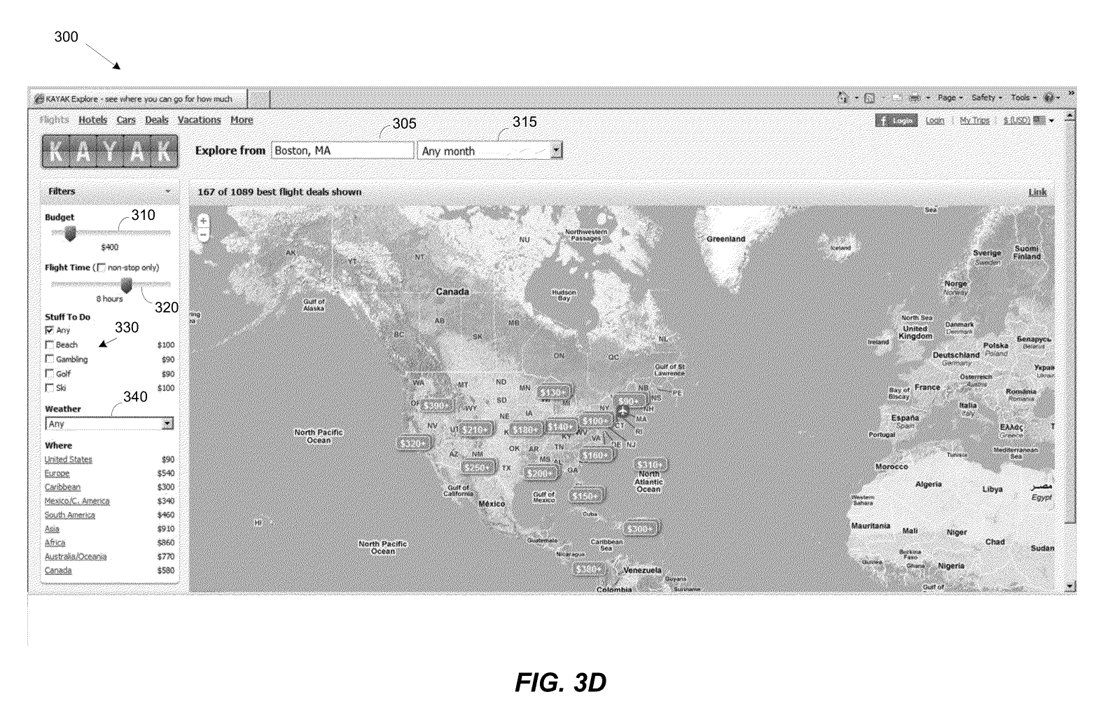

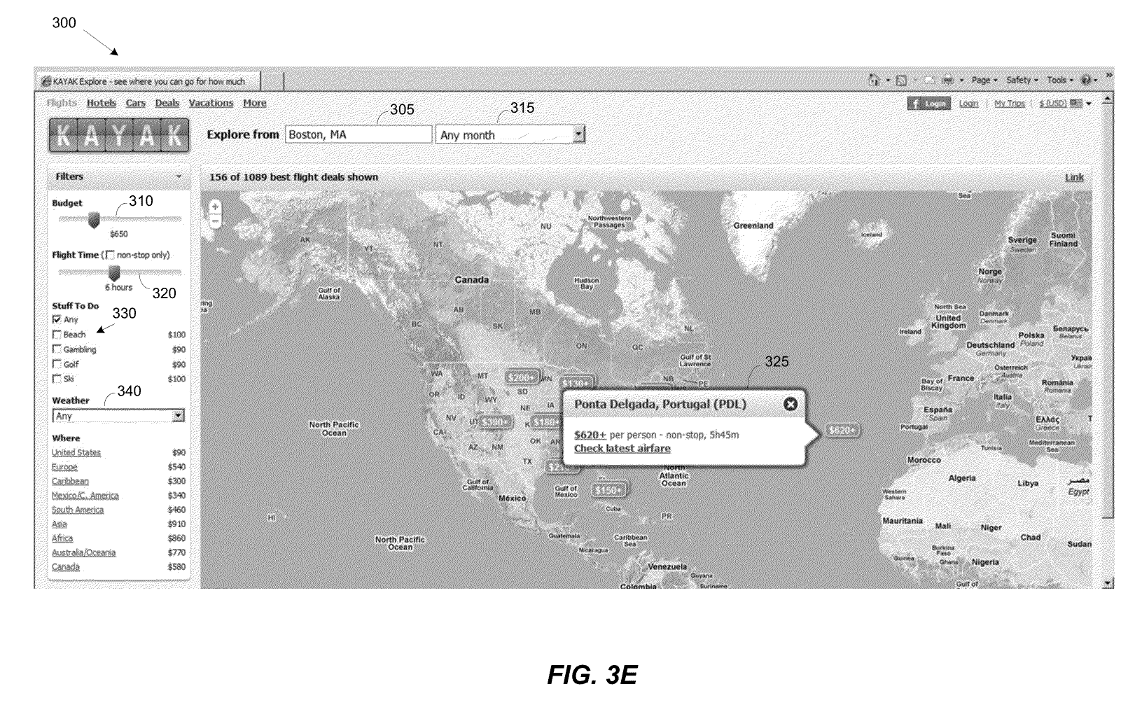

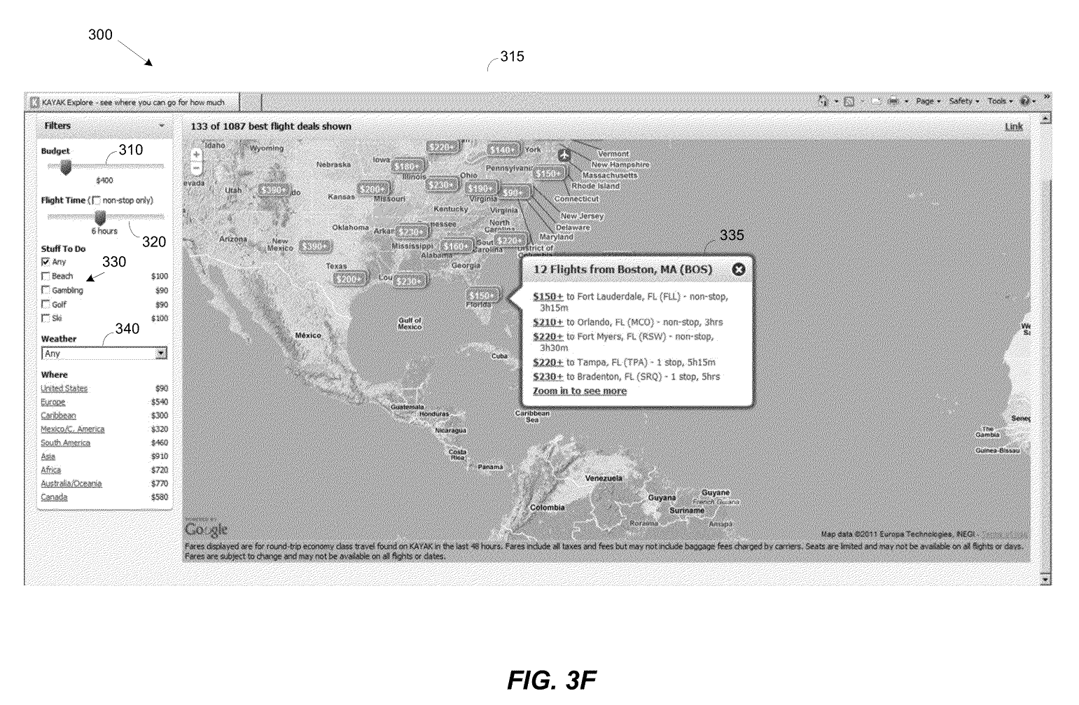

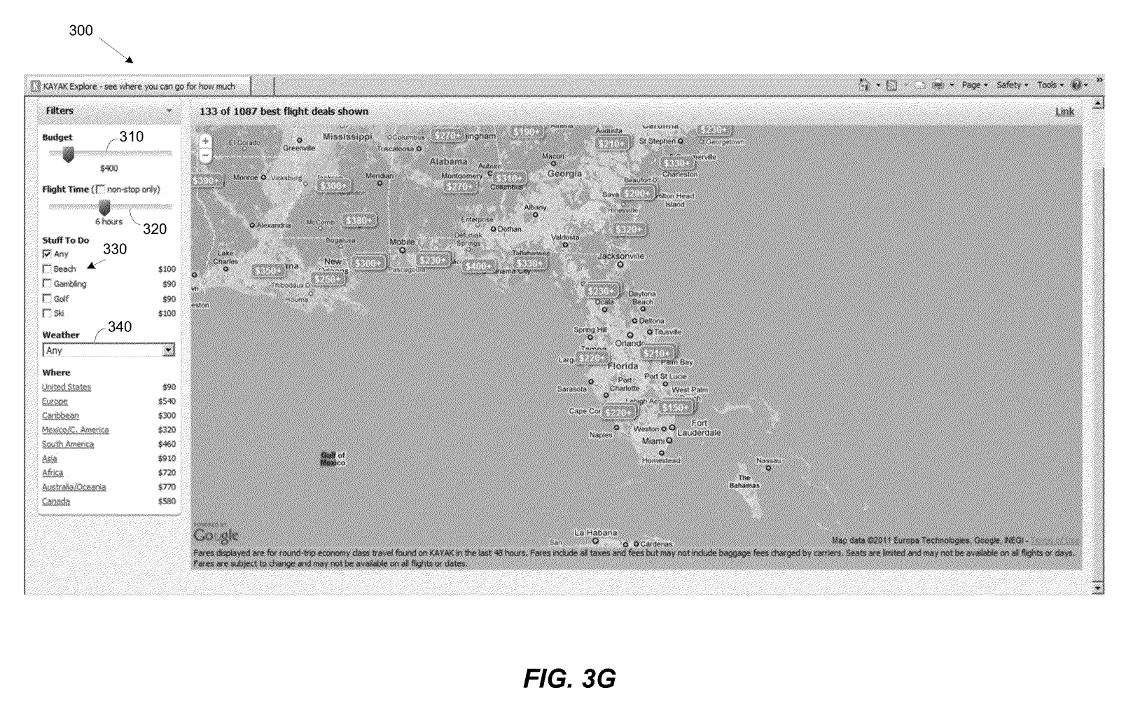

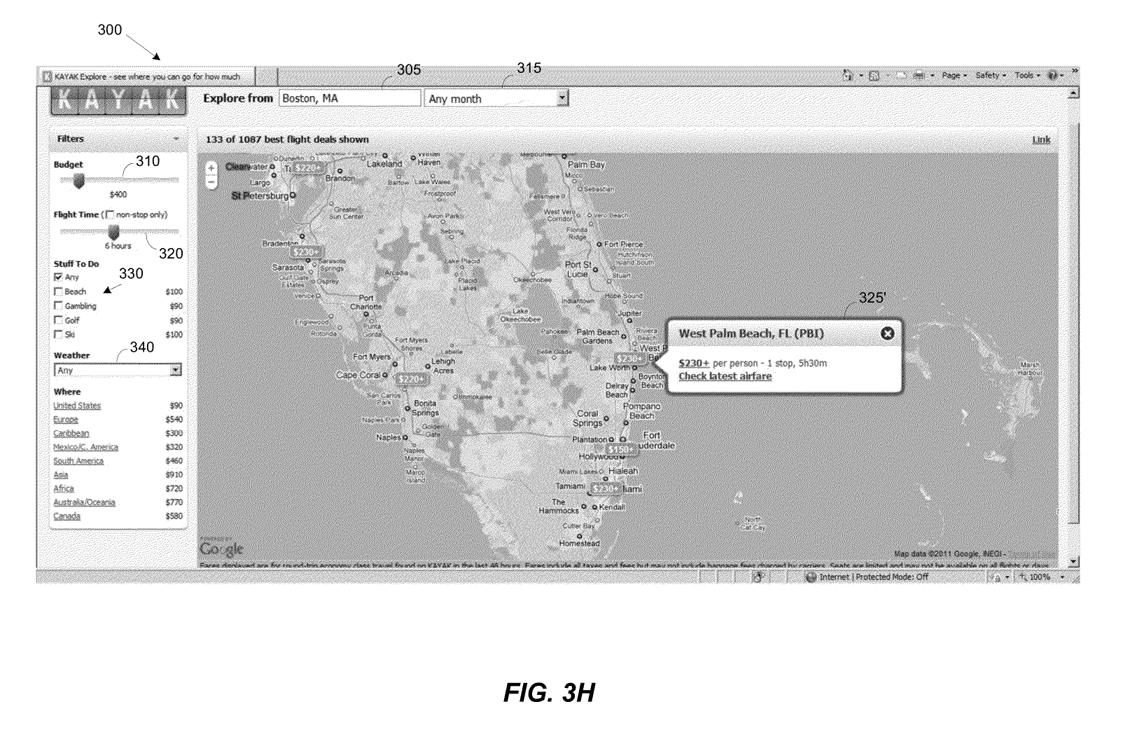

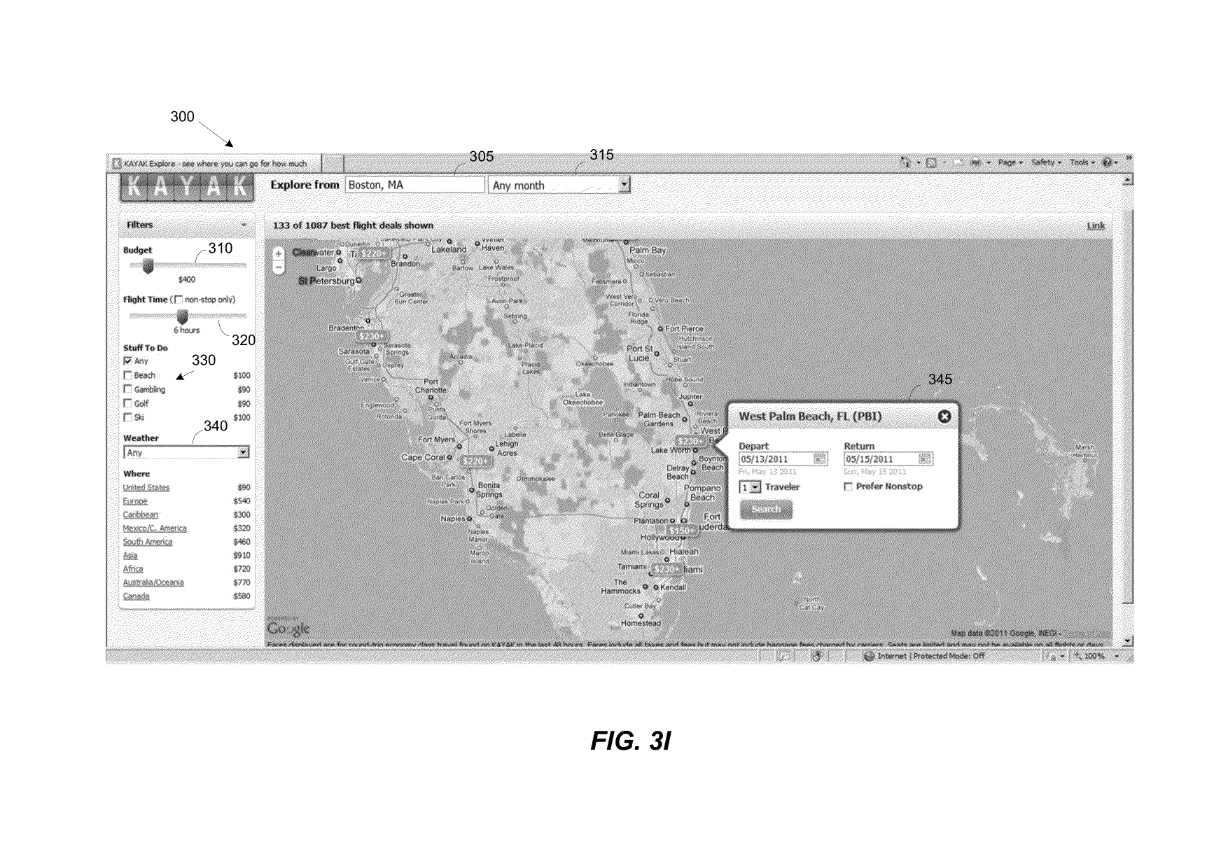

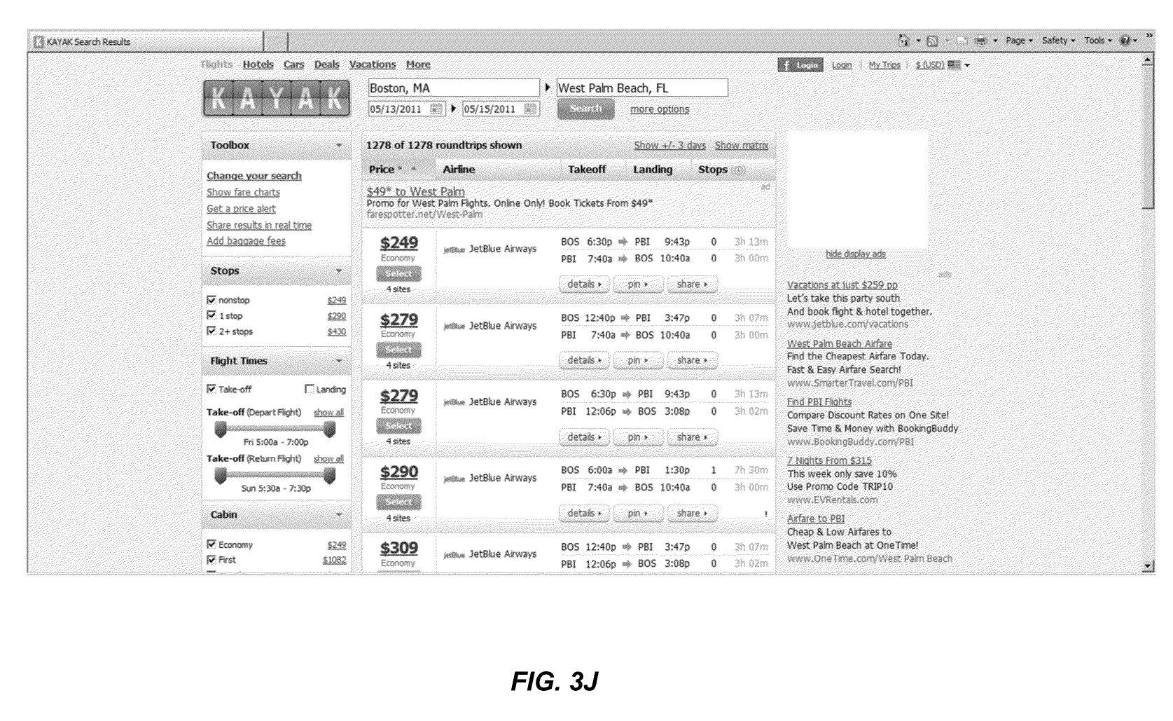

FIG. 3 illustrates some embodiments of an exploration tool that facilitate user exploration of potential destinations for a trip. In FIG. 3, exploration tool 300 initializes by displaying a map to the user and initializing a first search using default criteria, which in this case is simply the departure city of New York, N.Y. That is, exploration tool 300 includes a origin control 305 that allows a user to specify an origin or departure location (e.g., city, airport, etc.) from which a user would like to explore travel options. The exploration tool may display all available flights from the specified origin to respective destinations on the displayed map, or may present some subset of those flights. For example, the exploration tool may filter the flights based on any other criteria specified by the user, or may use such criteria to limit the search query. Thus, in FIG. 3, exploration tool 300 shows available flights departing New York, N.Y. and indicates on the map the respective destination. As such, a user can see numerous destination possibilities via a single search and without having to specify any destination.

As discussed in further detail below, a user may zoom into any area or region to see further destinations at a different level of granularity. In the embodiment illustrated in FIG. 3, a price (e.g., the best price) for flights to a given destination or destinations in a region are also displayed to the user so that the user can quickly get a sense for the cost associated with the different destinations. Exploration tool 300 allows a user to navigate about the map to see destinations to other locations on the globe not currently displayed and/or to zoom in on locations to see additional destinations and/or prices that are available in a particular region or area. In some embodiments, exploration tool 300 is implemented as a website accessible over a network, such as the Internet.

Exploration tool 300 includes an interface having a number of interface controls that allow the user to select a desired criteria so as to view the available destinations that meet the specified criteria. In addition to origin control 305, exploration tool 300 also includes timeframe control 315 that allows a user to specify when the user would like to take a trip. Exploration tool 300 also includes a budget control 310 that allows the user to select a price range as a criteria to filter the flights/destinations displayed to the user. In the example in FIG. 3, the default for the budge control is set to the maximum value such that budget is not a constraint on the default search. As discussed in further detail below, the user may place the slider on budget control 310 to indicate the maximum price the user is willing to pay for a flight. In response, the exploration tool will remove flights from the display that exceed the user specified budget, or the exploration may include the specified maximum price as part of the search query such that only flights that do not exceed the budget are obtained and presented to the user.

Exploration tool 300 also includes a flight control 320 that enables a user to select the maximum flight time as a criterion and/or to select whether the user is interested is seeing only non-stop flights or whether the user would like to see flight regardless of whether there are one or more stops as specified by the user. Additionally, exploration tool 300 includes an activities control 330 specifying things that the user would like to do at a destination and a weather control 340 that allows the user to specify the type of weather they are interested in. In FIG. 3, each of these controls default such that they do not limit or filter the flight results displayed to the user. As discussed in further detail below, other controls that allow the user to specify criteria may be included, as the aspects of the invention are not limited to any particular set of controls and/or types of criteria.

A user may manipulate one or more controls to specify criteria that are used to limit the search for available flights and/or filter the results presented to the user. One scenario that illustrates functionality of some embodiments of an exploration tool involves a user located in Boston, Mass. seeking a weekend getaway in accordance with the following statement: “I like to get away for the weekend every once in a while. I want to go someplace that I haven't yet gone, for under $400, and that is within the distance of a 6 hr flight. Warm is good.” For this example user, flight duration and budget may be an important factor. The weather may be a consideration, but may be less important. The above set of exemplary preferences for a trip may guide how the user sets the controls to specify criteria for acceptable flights to facilitate the user exploring options for a possible weekend trip.

FIG. 3A illustrates the results of using the exploration tool 300 to ascertain what destinations are available that meet the user's criteria. In particular, to explore options that comport with the example travel preferences described above, the user may indicate via the origin tool 305 that he/she would like to depart from Boston, Mass. Since the user may not have a specific time frame for the trip, the user may leave the timeframe control 315 set to “Any.” To discover flights that meet the user's requirements, the user may manipulate the budget control 310 to set the slide bar to a maximum flight cost of $400, change the flight control 320 to indicate a maximum flight time of 6 hours, and use the weather control to specify the preference that the destination be “Hot.”

Exploration tool 300 may then perform a search using the criteria provided by the user. For example, the tool may query flight information as well as other information about the destination (e.g., weather) to provide travel information to the user. The tool may use any available flight database, flight cache, one or more databases containing information about destinations, and/or any other information that facilitates obtaining flights/destinations that meet the user specified criteria. Methods for obtaining information on flights, hotels and destinations is described in further detail below. Once the user's criteria have been provided and a search performed, the travel information meeting the criteria may be displayed to the user. For example, the available flights meeting the user's selected criteria (e.g., flights obtained using the user specified criteria and/or filtered according to the user's indicated requirements) may be presented to the user on a map, indicating the price of one or more of the associated flights, as shown in FIG. 3A. The user can navigate the map to view any location in the world and/or may zoom in on the map for further details regarding flight and/or locations of interest. As shown by the presentation in FIG. 3A, the user may quickly view potential destinations and the price for corresponding flights that meet the specified criteria.

As discussed above, in the example scenario provided, the weather may be less important to this particular user, so the user may change the weather to “Any” to see what additional options may be available, as shown in FIG. 3B. As illustrated by the results presented on the map in FIG. 3B, additional flights further north become available once the weather restriction has been relaxed and/or eliminated. Additionally, the user may be curious to explore what other destinations may be available if the user were willing to accept longer flight times. Thus, the user may change the flight time to 7 hours or 8 hours, the results of which are shown in FIGS. 3C and 3D, respectively. Specifying a criteria having longer flight times allow, amongst other destinations, some destinations on the west coast to become available.

Likewise, the user may be interested in exploring what destinations become available if the price constraint were relaxed. For example, the user may decide that if the destination were desirable enough, the user would be willing to pay $650. To view destinations available using a criteria with a less stringent price constraint, the user may set the budget control 310 to a desired position (e.g., $650) to see what additional options become available. The result of doing so is illustrated in FIG. 3E. As shown, Ponta Delgada, Portugal, amongst other additional destinations, become available at the higher price point. A dialog box 325 providing additional information may be presented when the user clicks on a flight (e.g., using a mouse), hovers over the flight/destination, or otherwise indicates that further information detail is desired regarding a particular flight/destination.

After exploring various options, the user may want to further explore options in Florida as a weekend getaway due to the relatively low prices, short flight times and warm weather. The user may select (e.g., using a mouse click or by hovering over or near the destinations in Florida) the Florida destinations to view a list of the available destinations in the area along with the associated rates, as shown in FIG. 3F. For example, at the level illustrated in FIG. 3E, if multiple flights/destinations are available in a given region, the exploration tool may present one of the flight/destinations in the region and indicate that there are additional flight/destinations available in the general area. For example, the exploration tool may depict the icon indicating an available flight/destination as a stack to notify the user that additional flights are available. When the user selects the icon, a dialog box (e.g., dialog box 335) may be presented showing further flights/destinations in the region. Additionally, the user may zoom into the selected area by selecting, for example, the “Zoom in to see more” link provided in dialog box 335 in FIG. 3F. The result of activating this link is shown in FIG. 3G, which shows the magnification of the selected region. The process may be repeated to a level of magnification or zoom desired. For example, the user may zoom in again in the south Florida region on the Atlantic coast to explore options there, as shown in FIG. 3H.

As illustrated in FIG. 3H, in exploring south Florida, the user has selected West Palm Beach to get further information on available flights, and the exploration tool has presented dialog box 325′ in response. One of the options made available by the tool within dialog box 325′ is to check for the latest airfares to West Palm Beach. When this link is selected, a further dialog box 345 may be displayed that allows the user to pick specific flight dates and find actual flights available for the selected days. In the example illustrated in FIG. 3I, the user has selected a weekend in the middle of May for a potential vacation via the calendar interface provided in the search dialog box 345. Upon selecting search (e.g., by clicking on the “Search” button), the exploration tool 300 may query flight information and pricing engines (e.g., via a cache and/or flight information resources) to present flight information for the days specified by the user. FIG. 3J shows flight results obtained by querying flight information based on the information provided by the user. The user can then book a desired flight.

The above example illustrates how a user can quickly and easily explore travel options and destinations that meet a certain set of criteria without needing to specify a destination, or without needing to have any particular destination in mind. In addition, the user can dynamically change the criteria and observe what additional destinations become available or are no longer available as a result of modifying the criteria. Some embodiments of an exploration tool allow other filters and options that facilitate exploration of flight, hotel and/or destination options under a wide variety of travel circumstances, as discussed in further detail below.

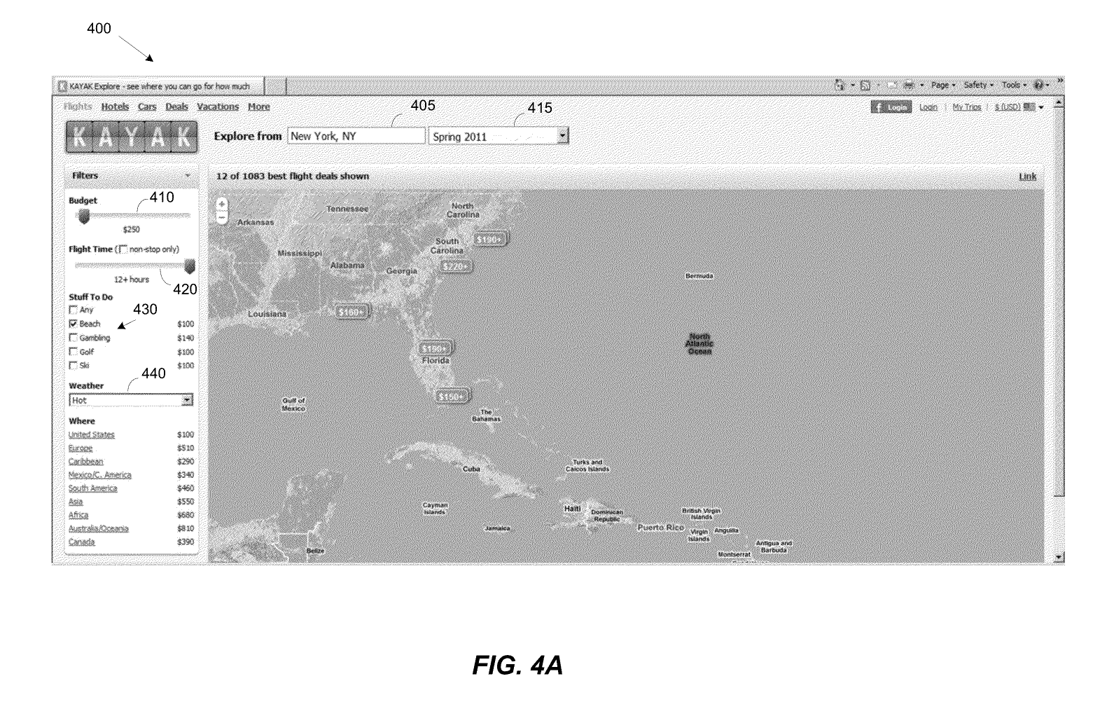

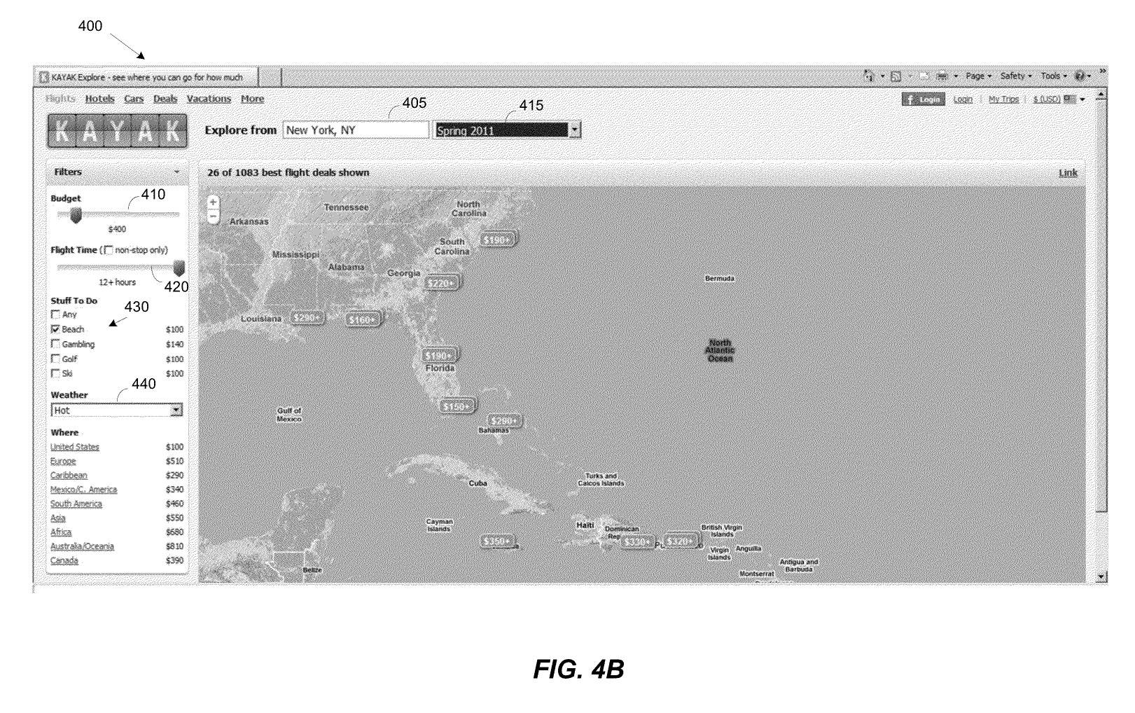

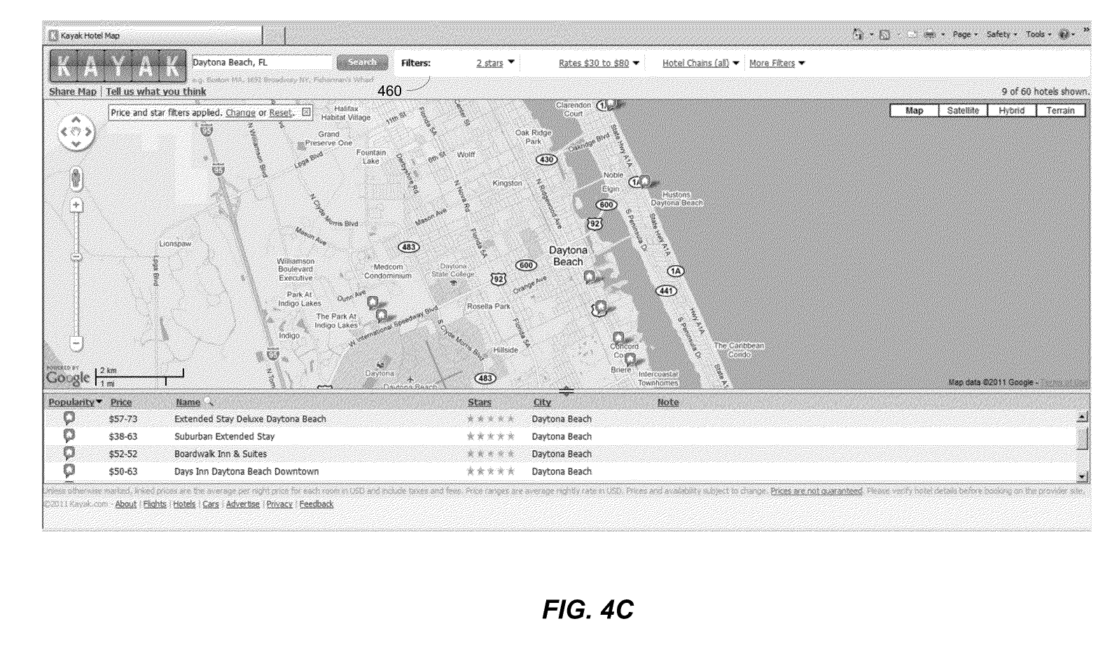

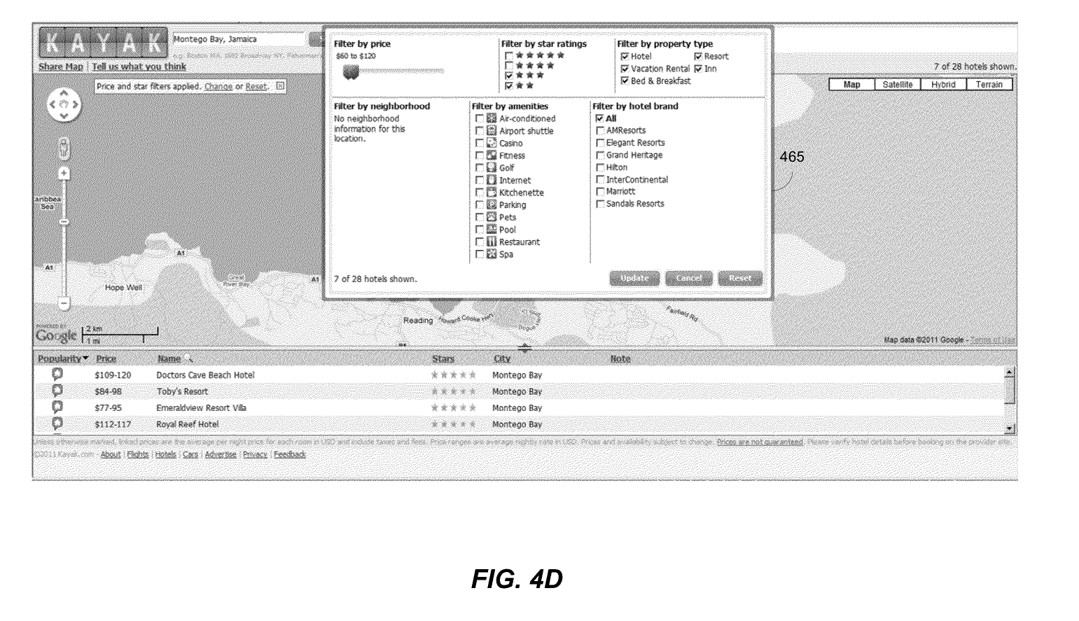

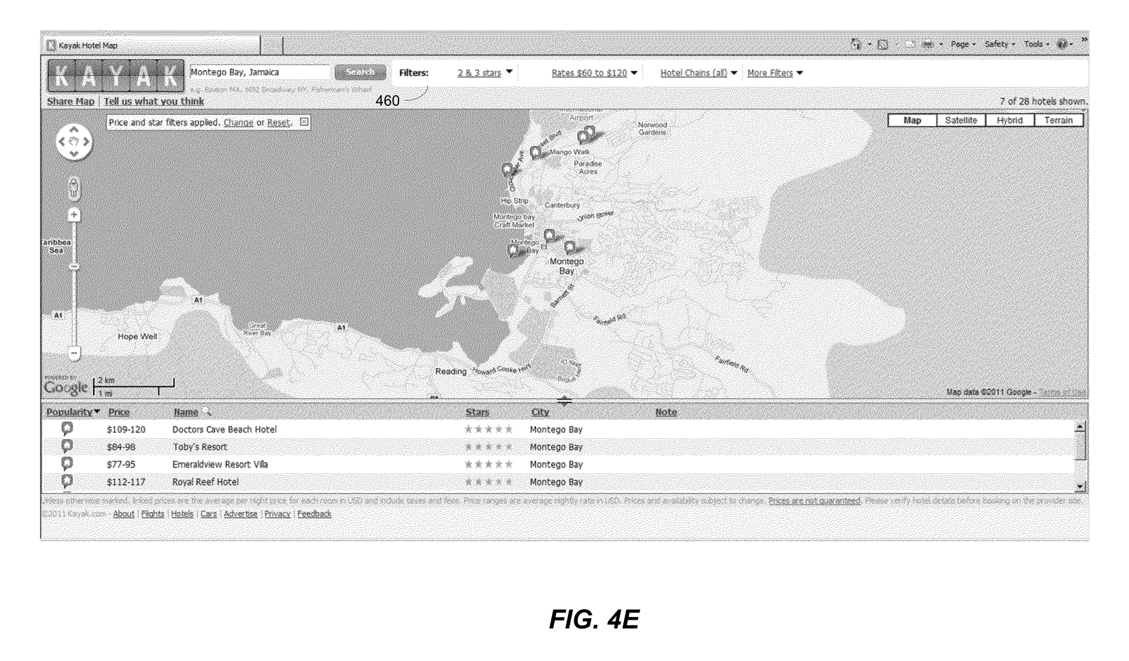

Another example scenario for which an exploration tool can be utilized involves a user with the travel constraints/preferences in accordance with the following statement: “I'm from New York and I'm coordinating a trip for 7 college friends of mine to a spring-break destination on the cheap. We aim to keep the cost per person to less than $800 including flight and hotel for a week. A beach is a must and an all-inclusive resort would be great if it meets our budget. Cheap is the key factor.” The above user may use an exploration tool to identify possible destinations by specifying corresponding criteria (e.g., by setting the controls to constrain the search space and/or filter flight/destination results). For example, as shown in FIG. 4A, the user may set the origin control 405 to New York, N.Y. and the timeframe control 415 to “Spring 2011.” The user may also specify that the destination have a beach and that the weather be hot by using activities control 430 and weather control 440. Since price is a key issue in this example scenario, an initial price point of $250 may be selected via budget control 410. FIG. 4A illustrates the results of exploring using the above criteria.

To quickly see what destinations become available as the price constraint is relaxed, the budget control 410 may dynamically varied by the user. For example, FIG. 4B illustrates the results when the price for the flight is increased (e.g., increased to $400). By varying the permissible price, the user can get a sense for what destinations might be available and/or what price point will make available which destinations. By doing so, the user can get a sense for what options are available and at what price point in an expeditious manner, avoiding tedious destination-by-destination queries. As a result, the user may be able to focus in on a number of suitable destinations using a significantly quicker and more efficient process.

The user may utilize this information to identify a number of potential destinations at which to explore hotel options and pricing. For example, the user may note that Daytona Beach, Fla. can be flown to relatively inexpensively and therefore may be a good candidate for a spring break location. In some embodiments, the exploration tool includes functionality that allows a user to explore hotel options, allowing the user to link to a hotel exploration portion of the tool (e.g., the exploration tool may include a “Hotels” link that accesses hotel/accommodation functionality). FIG. 4C illustrates the result of using the hotel exploration tool for the Daytona Beach location. In this example, the user has selected two star hotels in a price range between $30-$80 a night via filter control 460. The hotel exploration feature indicates the location of the hotel and lists the price range of the hotel per night, allowing the user the ability to obtain not only pricing information, but to visualize where the various hotels are located at the destination being explored.

In connection with the travel scenario described above, the user may also want to explore hotel options in Montego Bay, Jamaica. Even though the flights to Jamaica may be more expensive than Daytona Beach (see FIG. 4B), the user may want to explore hotel options there to see if a vacation can be planned there that still meets the user's overall budget requirements. FIG. 4D shows a user utilizing the exploration tool to explore hotel options in Montego Bay, Jamaica. The user has clicked on the filter control 460 and, in response, the tool displays a filter window 465 showing various filters that can be applied when exploring hotels. As shown, the filter allows the user to search for resorts, which was one option that the user was interested in exploring. Filter window 465 allows a user to filter based on location, star rating, accommodation type, amenities, brand, etc. It should be appreciated that other filter types may be used and/or the illustrated filters may be used alone or in any combination, as the aspects are not limited in this respect. FIG. 4E shows the results for hotel exploration using the filters selected in FIG. 4D. Using the exploration tool allows the user to quickly see which hotels are available that meet the specified criteria and their locations relative to the destination being explored.

According to some embodiments, an exploration tool includes, in the interface presented to the user, a control that allows the user to specify the timeframe in which the exploration tool should search for flights. For example, the user may specify “Any month,” as illustrated in the example described in connection with FIGS. 3A-3J, may select a season (e.g., winter, spring, summer or fall) as illustrated in the example described in connection with FIGS. 4A-4D, or may specify a particular month (e.g., May of 2011). Flights meeting the user specified criteria may then be aggregated over the specified timeframe and displayed to the user.

According to some embodiments, flight results are presented by displaying the lowest fare found during the specified timeframe. If a user clicks on the lowest fare (e.g., by clicking on the icon or stacked icon for multiple flights) and selects the fare, the user will navigate to the itinerary for which the lowest fare was found. The user may be given the option to see all fares, which will allow the user to navigate through all of the flights/fares found within the specified timeframe. Other ways of aggregating flight data and navigating multiple flights/fares may be used, as the aspects are not limited in this respect.

As discussed above, any criteria may be used to facilitate a user in exploring possible destinations and travel plans. A specified criteria may be used to constrain a search query (e.g., a live query or a query to a stored cache) or to filter results (e.g., results presented to a user may be filtered as the user modifies the criteria). Exemplary criteria include, but are not limited to, any one or combination of price, flight time (e.g., duration of flight), flight itinerary (non-stop, one-stop, etc.), activities available at destination (e.g., golf, gambling, skiing, etc.), geography of the destination (temperature, proximity to beaches, mountains, etc.), region (continent, country, state, city, etc.), available travel dates, language of destination (e.g., English or French speaking destinations), hotel star rating, hotel price, hotel type (e.g., hotel, inn, bed-and-breakfast, motel, resort, chain, etc.), hotel location or any other criteria that may be useful to a user in exploring travel options. In general, a user specified criteria does not include a specific destination, although it may include a region or area that includes multiple destinations.

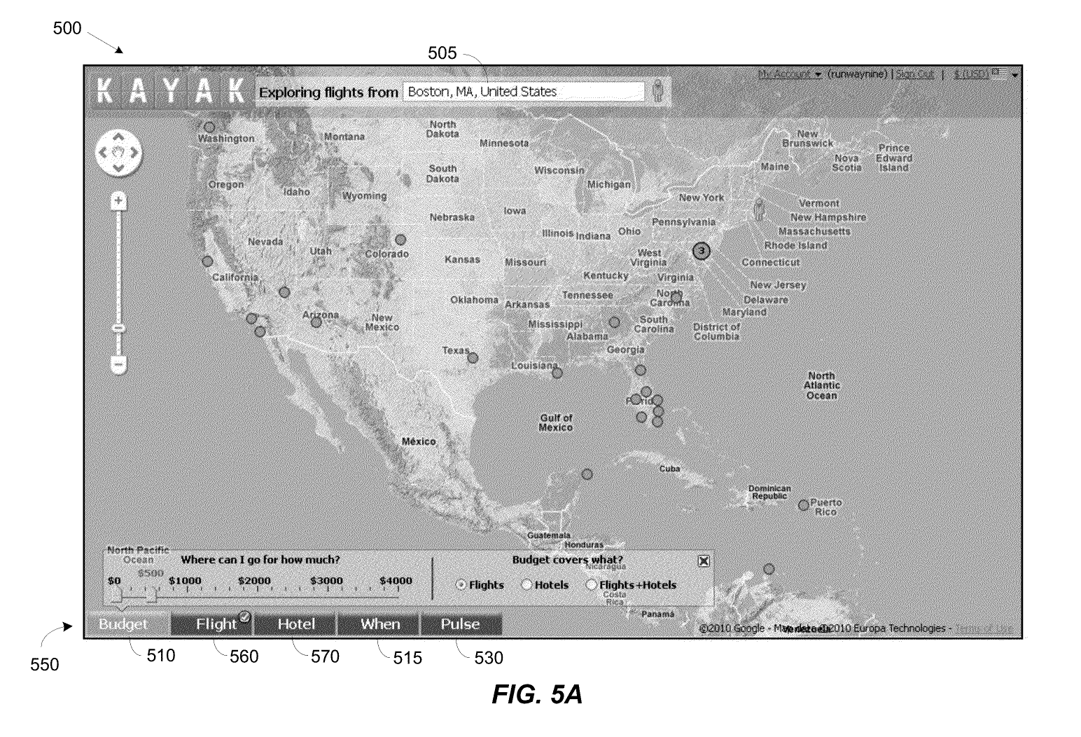

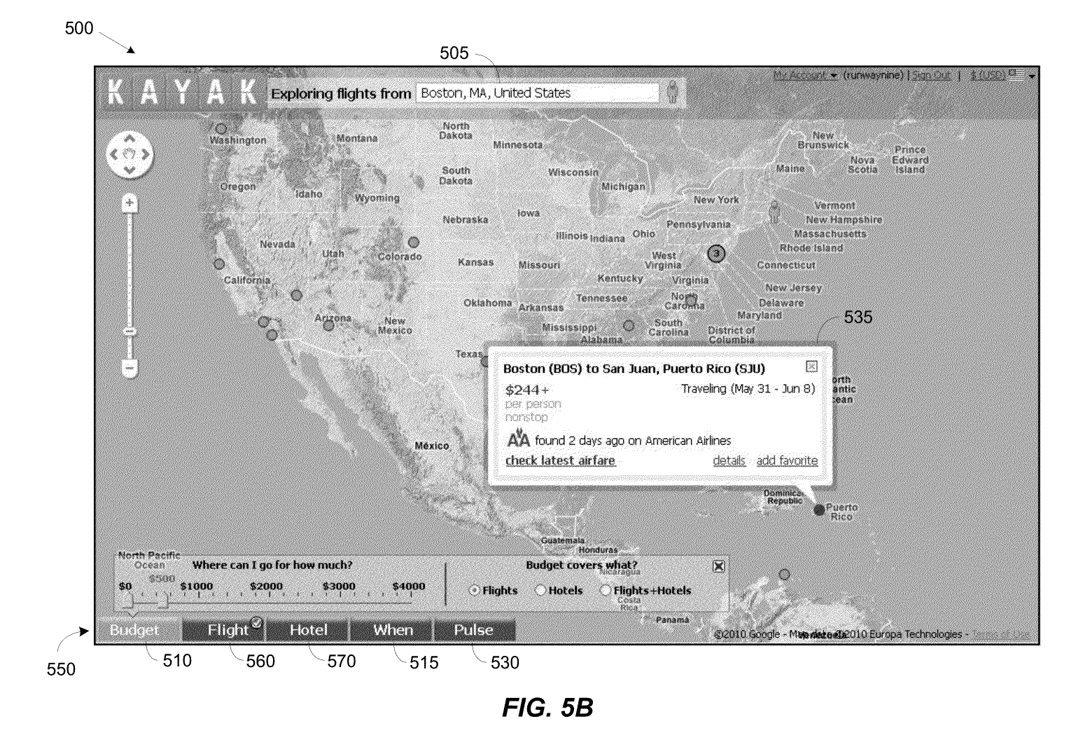

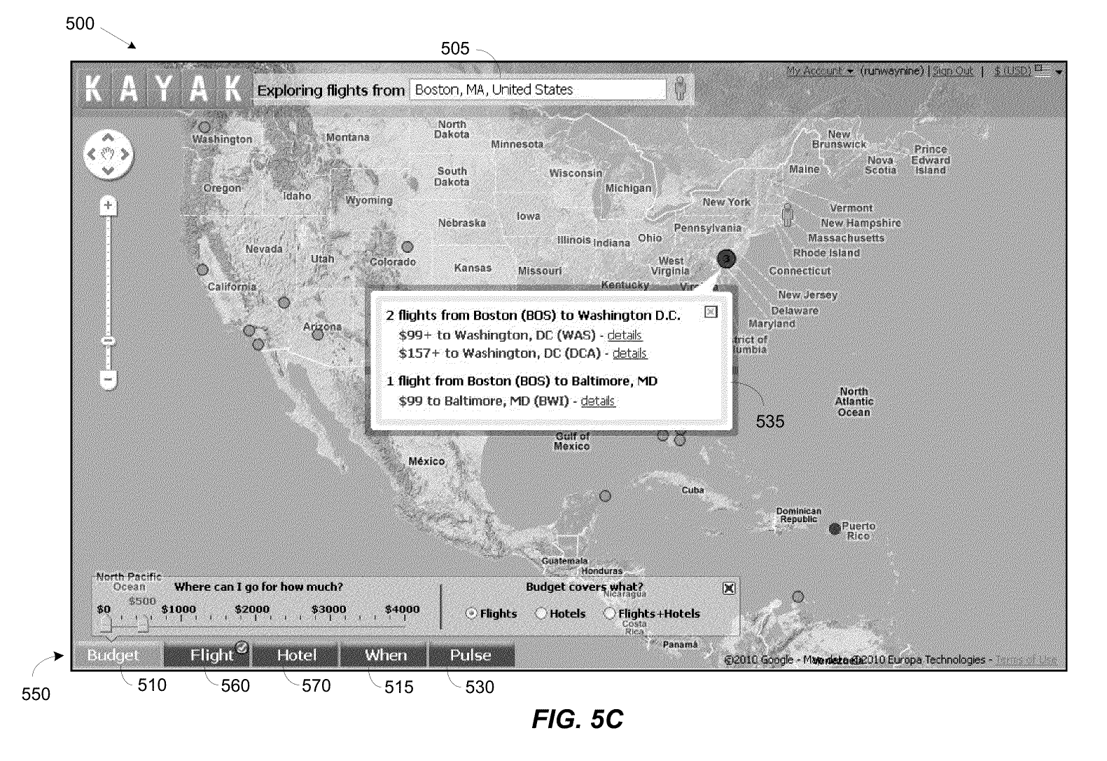

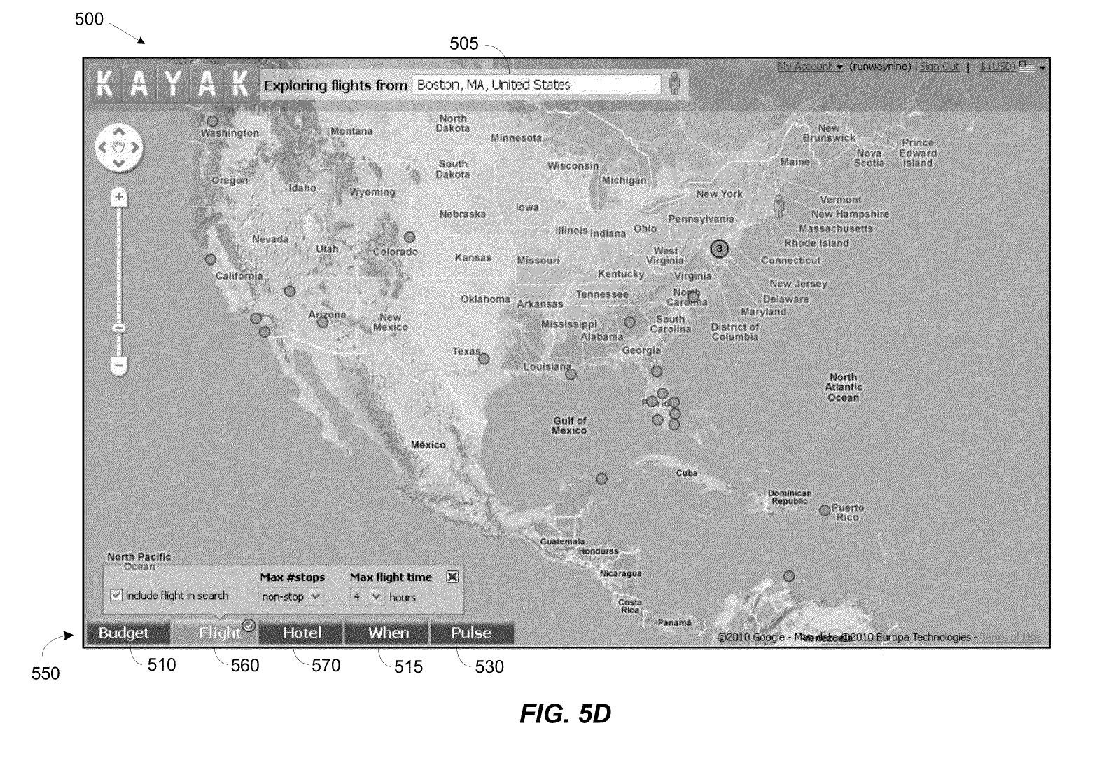

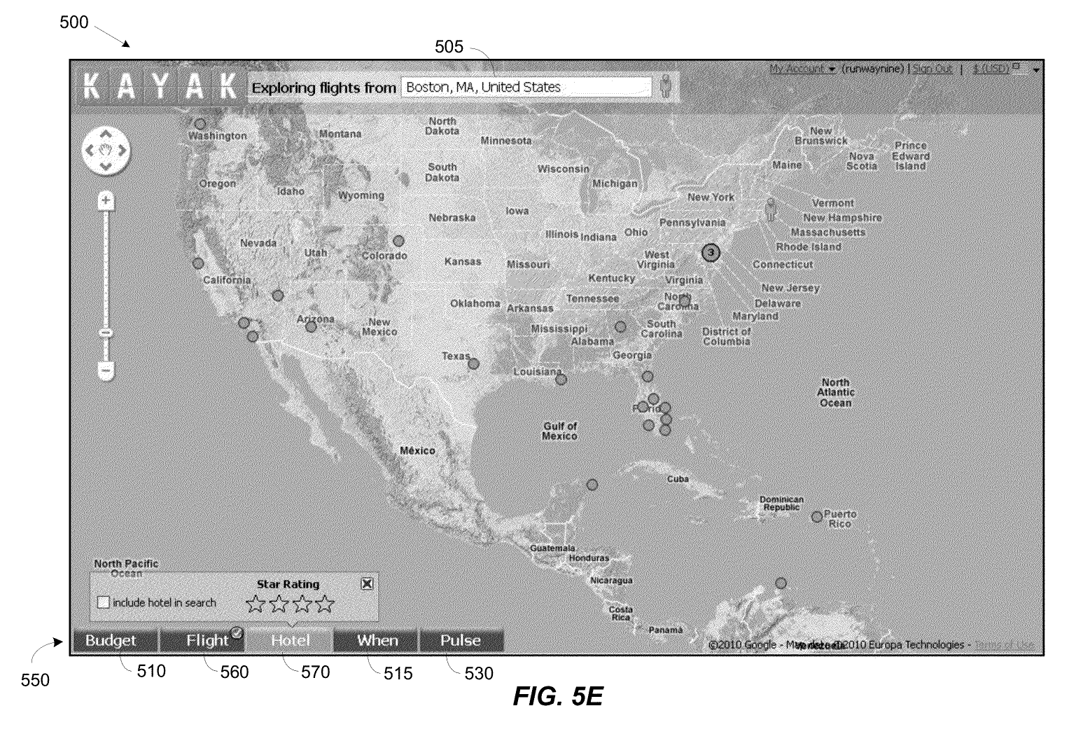

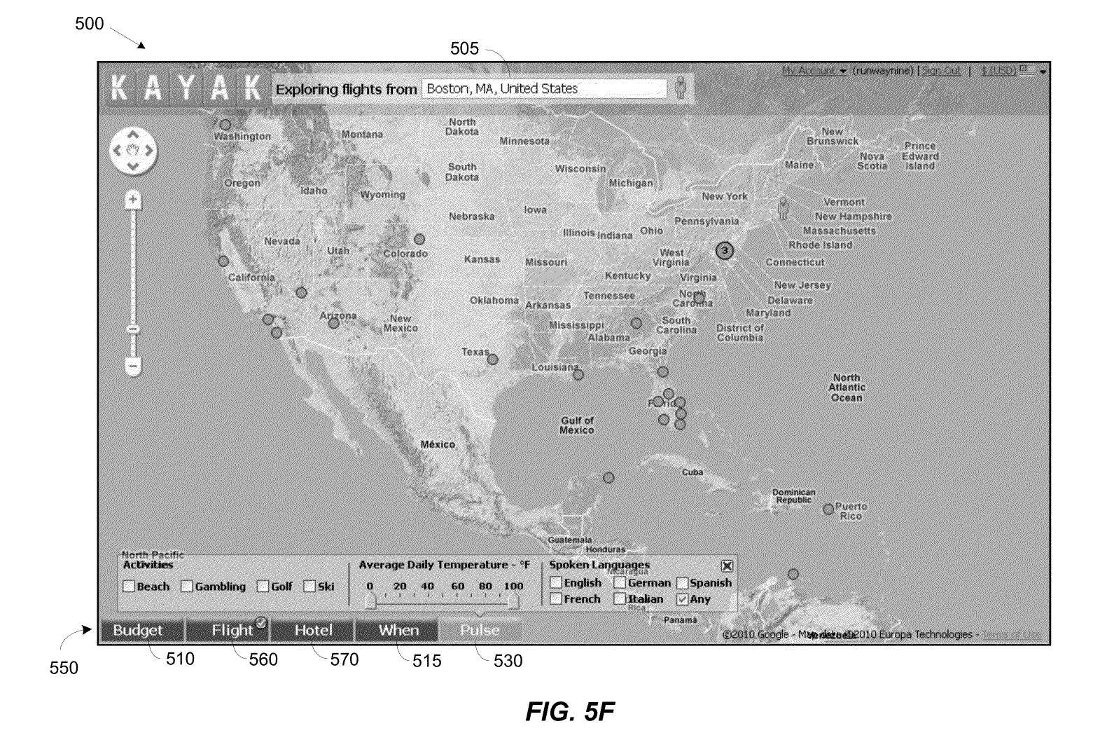

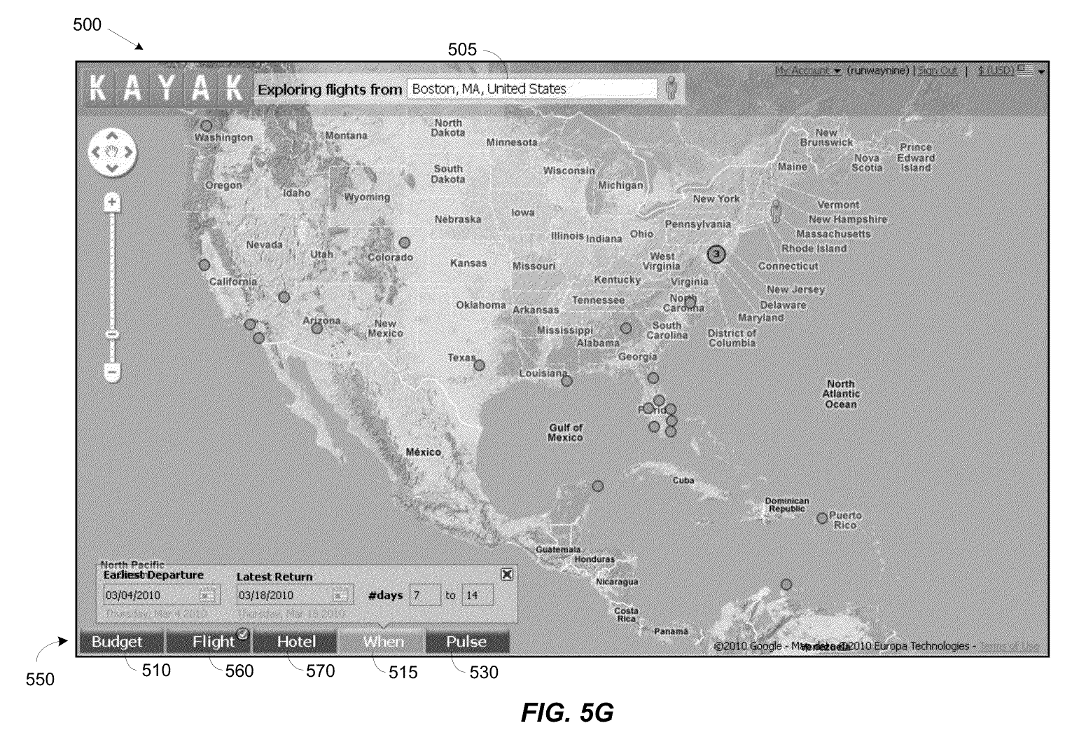

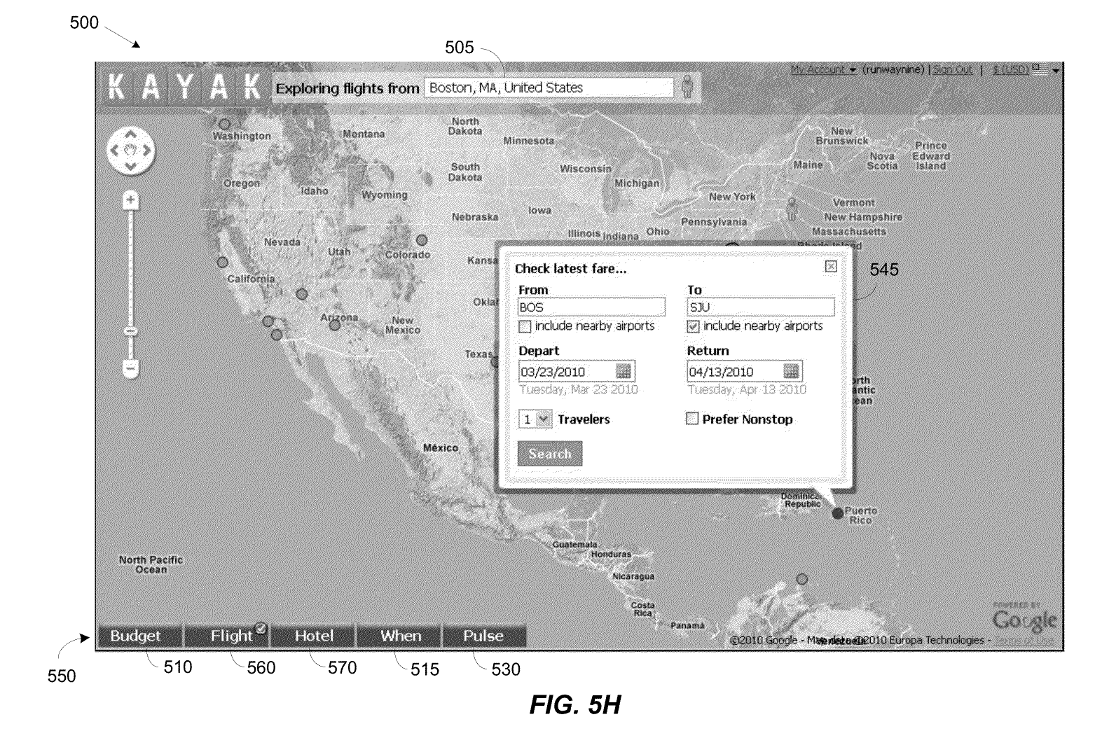

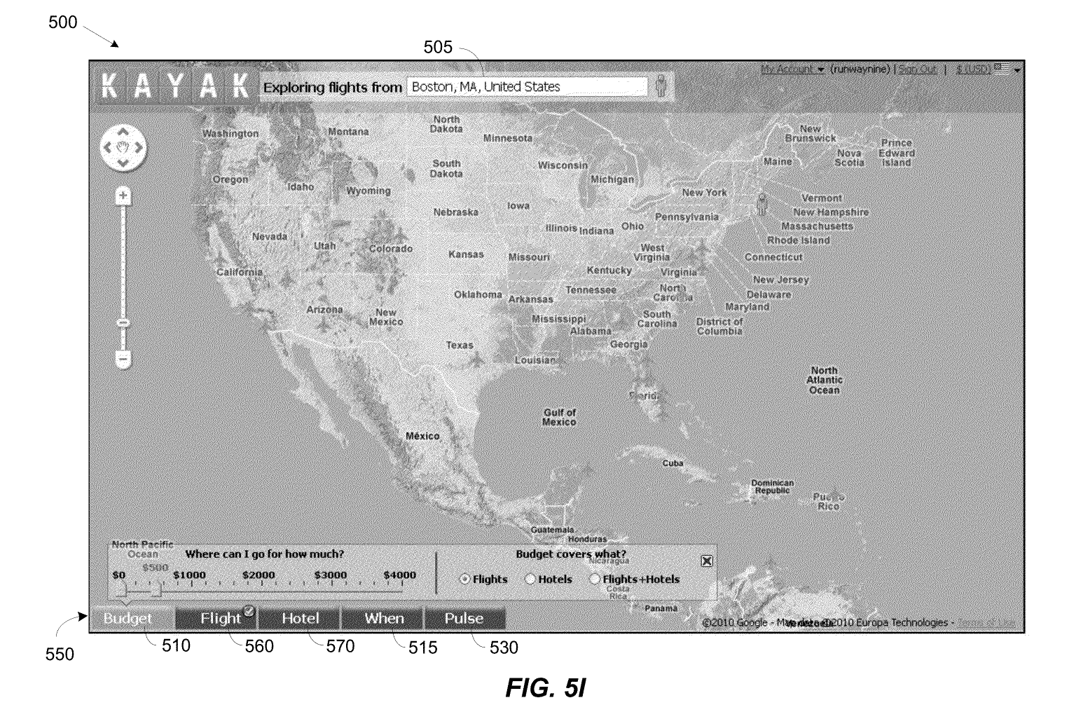

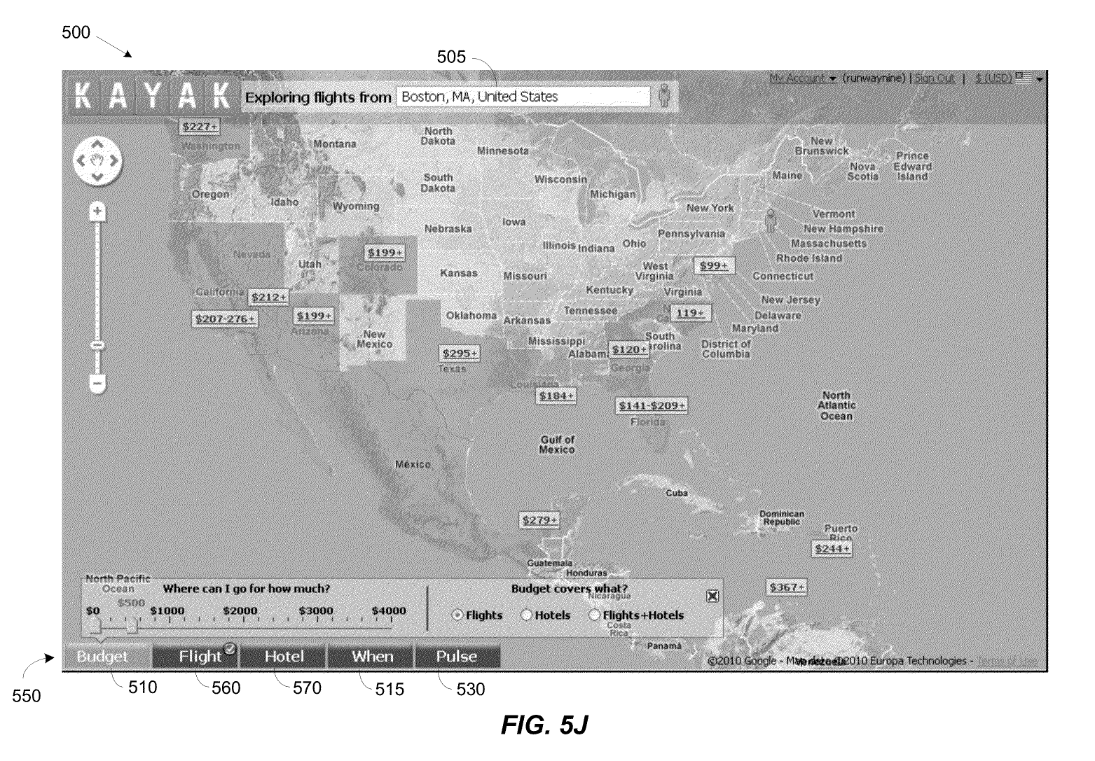

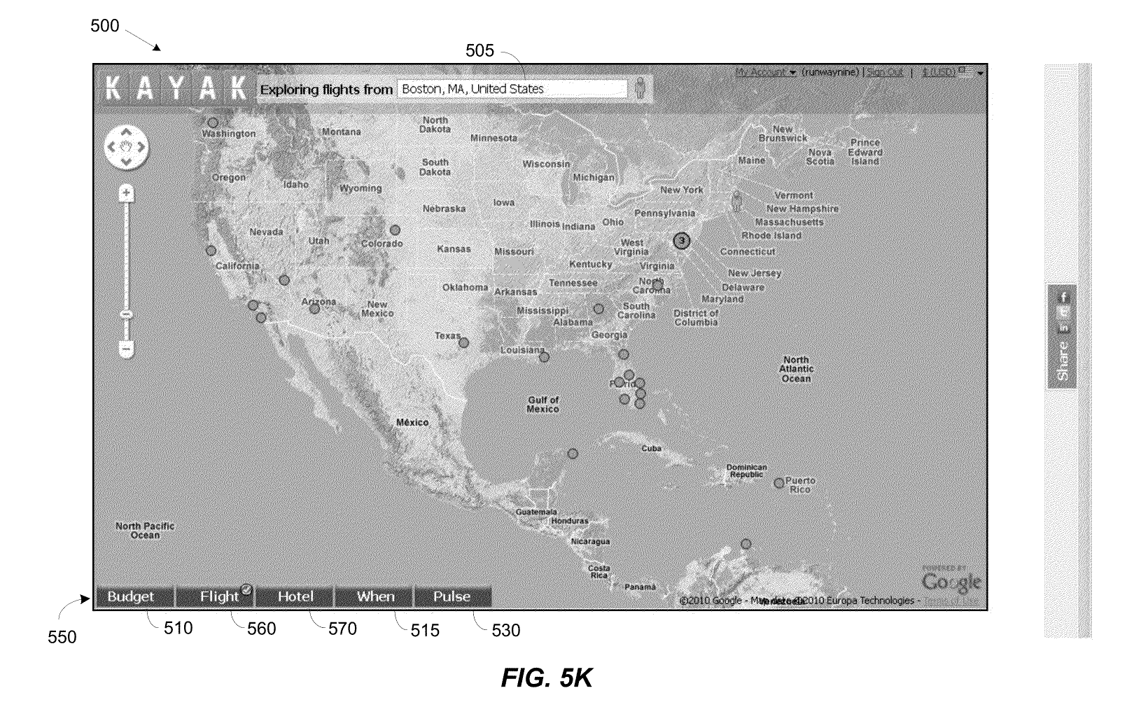

According to some embodiments, flight exploration features and hotel exploration features are integrated and the respective information may be provided simultaneously or by selecting a flight view or a hotel view available within the exploration tool. Some examples in this respect are described below in connection with FIGS. 5A-5K, which illustrate some embodiments of an exploration tool. Exploration tool 500 includes control panel 550 that includes budget control 510, timeframe control 515, pulse control 530. Control panel 550 also includes a flight control 560 that instructs the exploration tool to visualize flight/destinations that meet a specified criteria and a hotel control 570 that instructs the exploration tool to visualize accommodation information that meets the specified criteria.

Flight control 560 and hotel control 570 can be individually selected so that either flight/destination results or hotel results are displayed alone, or flight/destination and hotel results are displayed together, as discussed in further detail below. Additionally, flight control 560 and hotel control 570 may include other controls in connection with flights and hotels, respectively, as also discussed in further detail below.

In connection with exploration tool 500, in FIG. 5A, a user has selected a budget in the range of $0-500 using the slide bar presented when the user actuates budget control 510. In addition, the user can select whether this budget should cover flights or hotels individually, or should cover both flights and hotels together. In this instance, the user has selected that the budget reflects the flight budget only. The user may specify criteria regarding the flight such as selecting the maximum number of stops and/or the maximum allowable flight time, as shown in FIG. 5D. In this exemplary scenario, the user has selected the maximum number of stops to be non-stop and the maximum flight time to be four hours, the results of which are displayed on the map. Locations with multiple flights/destinations are labeled with the number of results that meet the specified criteria in the embodiment illustrated in FIG. 5D.

The user may also specify when the user is interested in traveling by clicking on the timeframe control 515, which is labeled “When” in the embodiment illustrated in FIG. 5G. In this example, the user has specified an earliest departure and latest return date within which the user would like to travel. The user may also specify other criteria for travel by using the pulse control 530 as shown in FIG. 5F. Using pulse control 530, the user may select activities, temperature preferences and spoken languages to establish criteria to be met by results displayed to the user. In the example illustrated in FIG. 5F, the user has decided to not further constrain the results in this respect.

Hotel control 570 may be used to establish requirements for hotels that the user would consider, such as the hotel ratings as shown in FIG. 5E. Any of the other hotel criteria described herein may also be presented via hotel control 570 such as accommodation type, amenities or any other criteria that a user may find useful in exploring hotel options. In this example, the user has decided not to include hotels in the search. After the user has selected the criteria, the user may search and the available flights that meet the user's criteria may be presented to the user as an overlay on a map, as shown in FIGS. 5A-5K.

After the results have been presented, the user can then interact with this information, for example, by clicking on any of the indicated destinations. For example, in FIGS. 5B and 5C, the user selects Puerto Rico and the Washington D.C. area, respectively, to obtain additional information on flights to these destinations, and in particular, to view pricing on the displayed flights. For example, the user may select “check latest airfare” option in dialog box 535 in FIG. 5B to search for available flights. In response to selecting this option, dialog 545 may be presented as shown in FIG. 5H to allow the user to check on the availability of actual flights from Boston to Puerto Rico on specified departure and return dates.

FIGS. 5I and 5J illustrate other ways that information can be presented to the user, for example, by showing flights as airplane icons, hotels as building shaped icons, shadowing regions that the user can reach according to a specified criteria and displaying flight prices on the map. It should be appreciated that travel results meeting a particular criteria may be presented in any suitable manner and are not limited to any of the specific ways in which this information is illustrated as being presented in the exemplary embodiments described herein. As shown in FIG. 5K, the user can share the filtered and zoomed state of the map by sharing a link by email, facebook or twitter, or using some other type of social or communication media. The relevant filtering information (dates, destinations, type of vacation, etc) and the zoom level may be encoded in the URL so that the recipient can reproduce the view sent by the user by clicking on the link. In this manner, a user can share his/her exploration with another interested party who can link to the travel option being explored by the user.

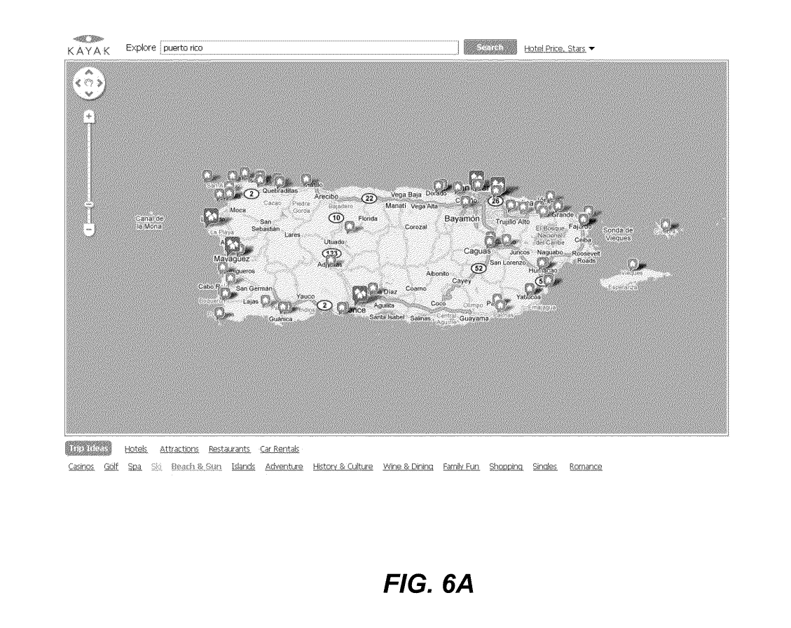

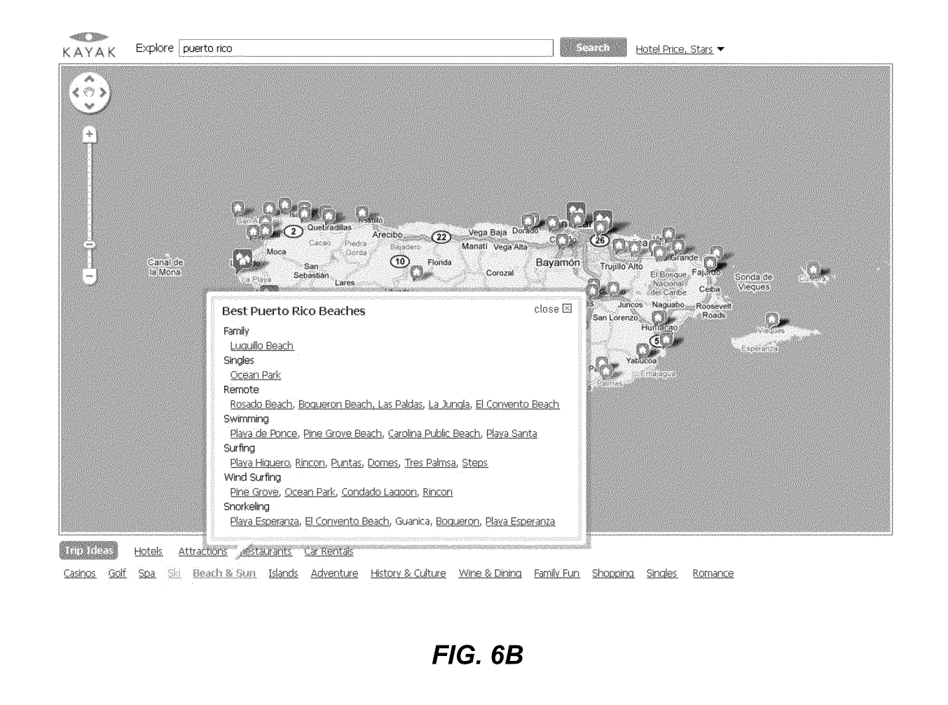

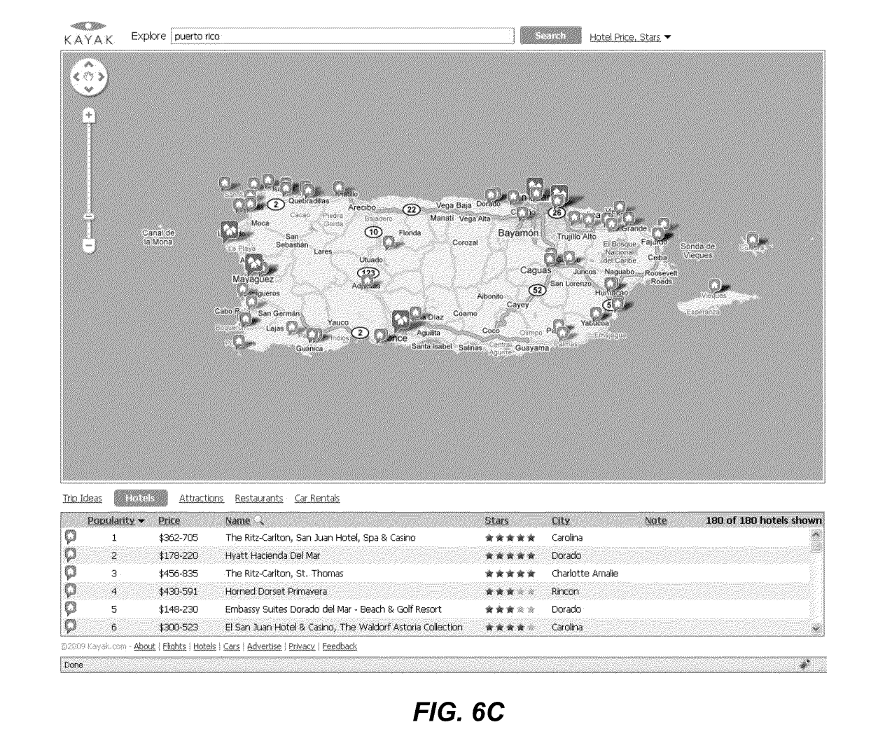

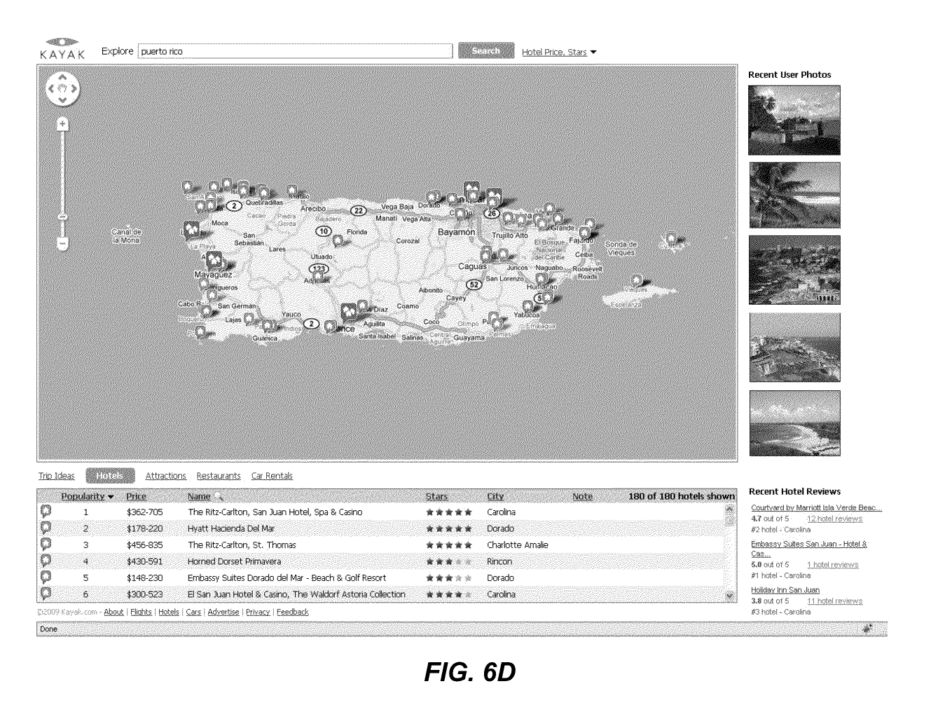

FIGS. 6A-6D illustrate a user exploring Puerto Rico as a potential destination in accordance with some embodiments. FIG. 6A illustrates Puerto Rico with hotels on the island presented to the user. The user may also want to explore what Puerto Rico has to offer with respect to activities, attractions, restaurants, etc., and can select from a number of explore options. For example, the user can highlight “Trip Ideas” to explore trip options including golf, spa, beach and sun, islands, adventure, history and culture, wine and dining, family fun, shopping, singles and romance. Other explore options can additionally be included, as the aspects are not limited to any particular set of options or categories. In FIG. 6B, the user may select beach and sun to display related information that the user may find useful in exploring Puerto Rico's beach options and related activities.

The user may also explore hotel options by highlighting “Hotels” as shown in FIG. 6C. Available hotels, star ratings for the hotels and prices may be listed for the user, along with the locations of the hotels. The user can zoom in on a particular hotel and obtain further detailed information on the hotel. FIG. 6D illustrates further travel information that may be presented to the user, including photos of the destination, online hotel reviews, etc., to further facilitate the user's exploration of a particular destination or locale.

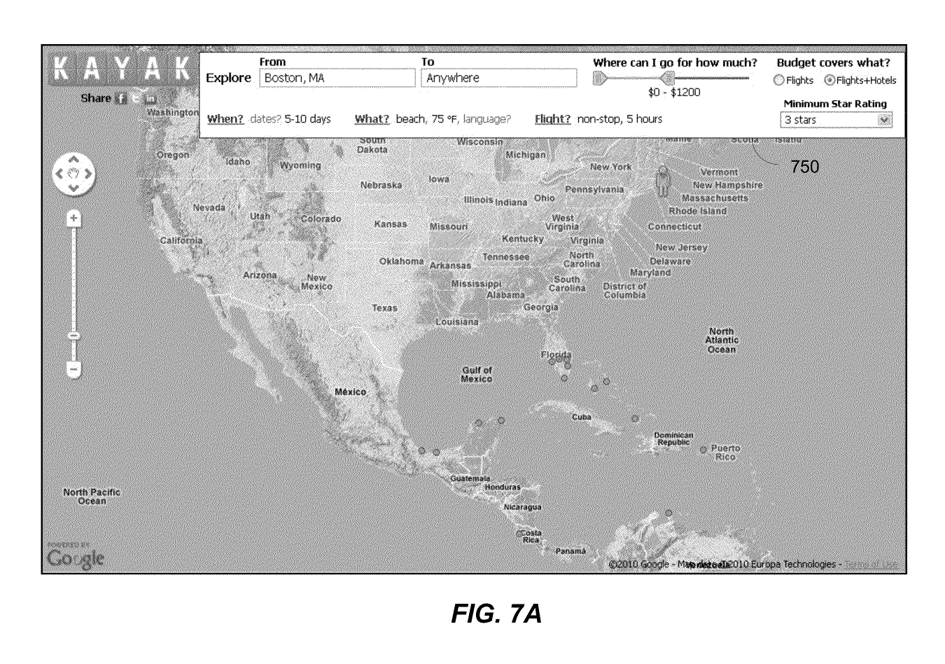

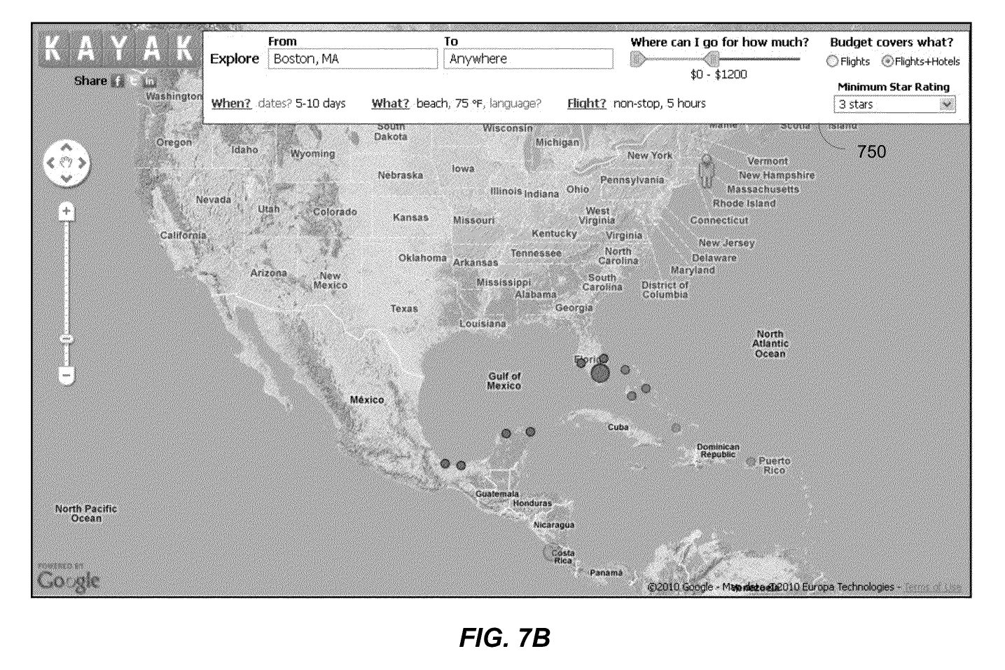

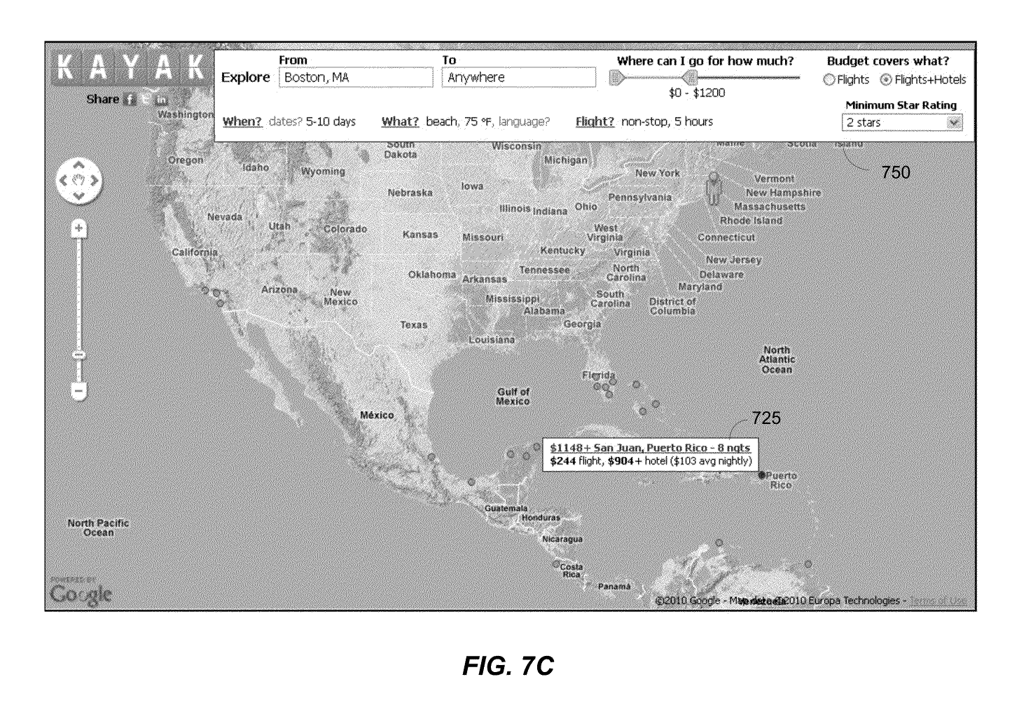

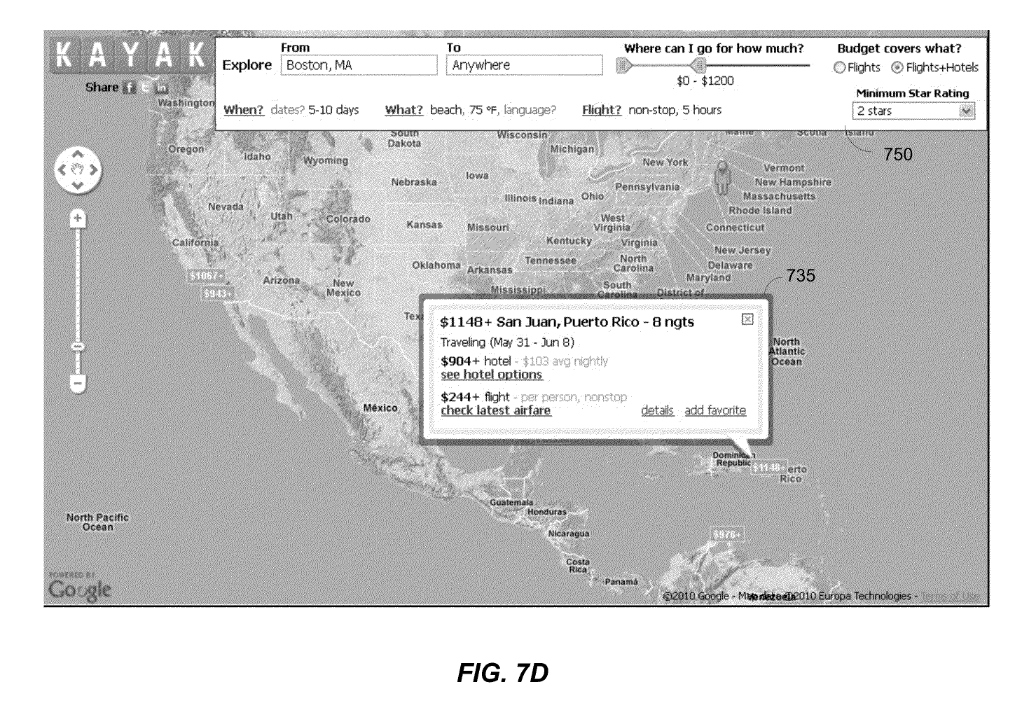

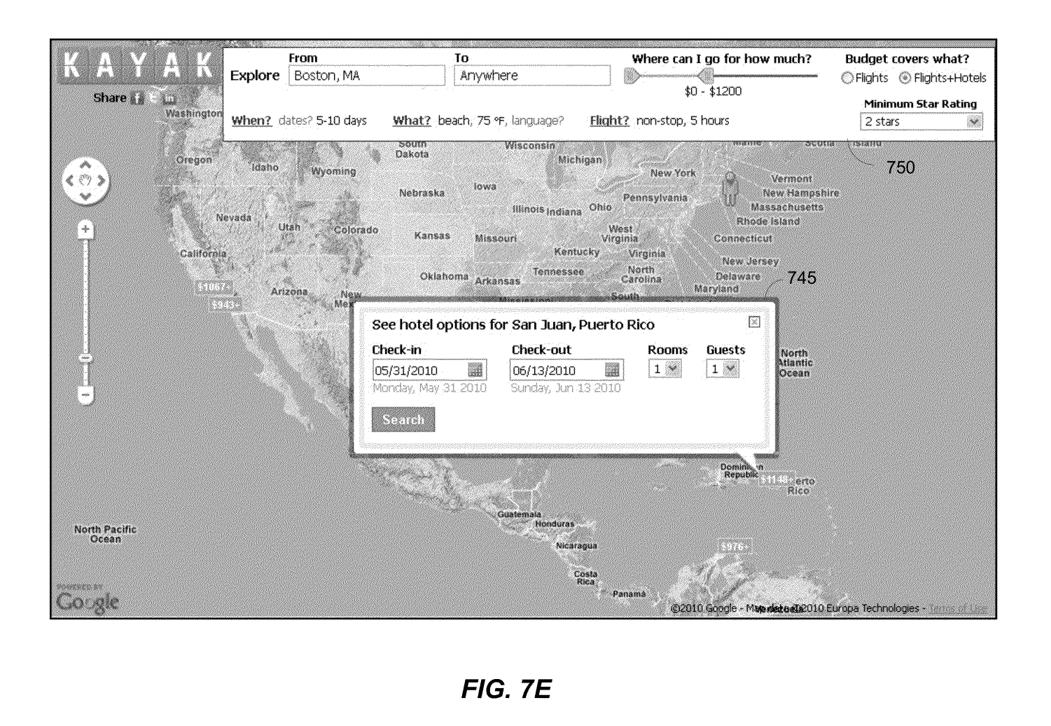

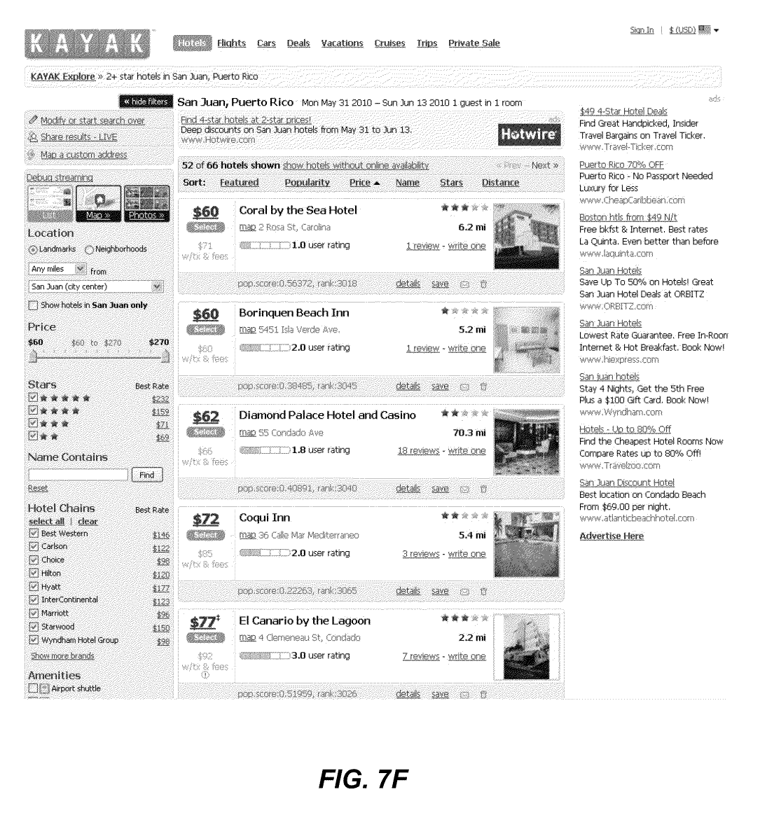

As discussed above, in some embodiments, flight and hotel exploration are integrated together. FIGS. 7A-7F show a user indicating a criteria in which the budget includes both flight and hotel. Using the control panel 750 shown in FIG. 7A, the user has specified a budget of $1200 to cover both flight and hotel for a 5-10 day vacation at a destination having a beach and temperatures in the vicinity of 75 degrees. The flight must be non-stop with a maximum flight time of 5 hours, and the hotel may be 3 stars or less. The available destinations that meet this criteria are shown in FIGS. 7A and 7B using different representations. The instance in which the user has selected Puerto Rico to view available flight/hotel options is shown in FIGS. 7C and 7D. As shown, the flight and hotel for a 8 night stay comes within the budget set by the user.

If the user desires, the user can explore hotel options and book a hotel by selecting the “see hotel options,” for example, as provided in the dialog 735 in FIG. 7D. The result of activating this link is illustrated in FIG. 7E, where a dialog 745 is displayed that allows the user to specify check-in and check-out dates, the number of rooms and the number of guests, etc., in order to explore hotel options in Puerto Rico and book a hotel if desired. As shown, the user selects the dates for his/her stay in Puerto Rico. FIG. 7F shows the resulting interface which allows the user to explore hotel options during the specified times and book a desired hotel for the vacation. Flights and hotels can be integrated in other ways such as showing hotel locations on the map along with flight fares when the user zooms to an appropriate zoom level on the map, or when the user is zoomed out, an aggregated hotel indicator can be displayed on the map. Other presentations of flight and hotel information can be used, as the aspect are not limited to particular types of presentations and/or integration.

In addition to the examples described above, further examples of travel circumstances that may be facilitated or questions answered using embodiments of an exploration tool described herein are provided below.
“Where can I go during February vacation, that is warm (>70 degrees during the day) and does not cost more than $4000 for flight and budget hotel for 4 people?”
“I want to go some place warm/sunny for Winter Break were I can lay on the beach and tan. I can be gone from February 15-February 25. I'd like to ‘be’ at my destination for a minimum of 3 days. I'd like to spend no more than 4-5 hours flying time. I'd like to spend at most approx. $3K for flight and hotel for a family of 4 (so roughly $800 pp).”
“I want to go to a warm, sunny island that is not overbuilt. I want it to be able to explore the island in a few days and really feel like I got to know it—so not too big. I do not want to be surrounded by big hotels and high rises. I want to snorkel so good reefs would be a plus. I could go during Christmas school break.”
“Where can I fly during the summer break for up to $1000 and they speak French?”
“I want to go on a 4-5 day get-away ski vacation with my husband to ‘real mountains’—so may be the ones out West and ideally ones in France, Switzerland and Italy. I want to keep the costs down a much as possible.”
“Is it cheaper to go to Peru or Laos over Christmas including flight and medium level accommodation?”
“This summer we want to go to Europe, not sure where, may be Spain may be Paris. Need to plan around kids' summer activities. Don't mind 1-stop, price is a factor, not going 1st class, don't want to go ‘cattle car’ since you then spend a day recovering.”
“Which are the cheapest Caribbean islands to fly to in March?”
“Which island in the South Pacific would be the most cost effective one to go to in April?”
“I need to visit parents in Rotterdam in this fall. I don't have specific dates in mind, but just want to find the cheapest direct flight. Would like to be gone a week, but it all depends on the cost of the flight—need to save money.”
“I want to fly to Russia sometime this summer with my daughter (who was adopted from there) as cheap as possible. I can leave as soon as school gets out (around June 28th and must be home the week before school resumes, around August 21st). I'd like to stay at least a week, but not more than two.”

As should be appreciated from the foregoing, embodiments of the explore tool described herein can make travel planning that conventionally would have been very time consuming, relatively quick and easy. By presenting travel results (e.g., flight, hotel, activities, etc.) for multiple destinations that meet a user's criteria, the user can avoid having to query flight and hotel information on a destination-by-destination basis. In addition, the user can dynamically vary the criteria and be presented with updated travel results so that a user can quickly understand what destinations are available for different criteria.

Travel results presented to the user may be obtained from any suitable source. For example, embodiments of an exploration tool may use any available resource to compile the information used to present travel information to the user. With respect to flights, any available pricing engine (e.g., ITA, Expedia BFS, Amadeus, etc.), Global Distribution Systems (GDSs), Online Travel Agencies (OTAs), and/or direct airline websites (collectively referred to herein as “flight information resources”) may be used to obtain flight options to present to the user. Queries to obtain flight information may be performed via XML APIs or HTTP integrations that allow the flight search service to pass different parameters affecting complexity and guiding the search. These parameters range from the number of maximum stops to be allowed in the particular flight search, to the graph-theory complexity of the search algorithm for combining different airlines for interline solutions (combinations of a two separate airline carriers, with interlining agreements).

However, requesting all available flight information corresponding to a particular user query directly from the appropriate flight information resources each time a user makes a query can be time consuming. This may reduce the desirability and/or usability of the explorer tool which provides information for multiple destinations and displays those to the user. Thus, to avoid the overhead involved in querying the flight information resources for all possible flight solutions that meet a user specified criteria, all or some portion of the flight information available at the flight information resources may be cached by a travel search service (e.g., travel search service 130 illustrated in FIG. 1). When a user requests flight information corresponding to one or more given criteria, the flight search service can query the cached information to obtain the flight solutions/results that meet the one or more criteria instead of incurring the time associated with querying the flight information resource(s) directly to obtain the available flight solutions.

Any of the cache techniques described in the Flight Caching reference incorporated herein may be used to obtain flight results in connection with a user utilizing an exploration tool. Embodiments of the exploration tool may be used in connection with conventional queries, conventional caching techniques and/or one or more intelligent caching techniques described in the Flight Caching reference. Hotel information may be obtained in a similar way as flight information. For example, hotel information such as availability, pricing, star ratings etc. may be obtained from any resource where such information is made available. This data may be cached and learning algorithms may be applied to the cache to ensure that the data is accurate. In some embodiments, average nightly rate per star per city (to avoid false expectations based on outlier hotel pricing) may be used to determine prices presented to the users. This data may by obtained from historical hotel data, from a live hotel cache, or other suitable resources.

Other information obtained in connection with user-specified criteria may be obtained in similar ways, for example, by accessing electronic databases, online resources and/or other sources of information. For example, information about destinations such as temperature, geography such as beaches, mountains for skiing, etc. can be obtained from any available source, such as an electronic almanac that provides such information. For example, temperatures can be obtained from historical monthly averages or computed in other ways. Such information may be obtained in any fashion, as the aspects are not limited to any particular source of information or method of obtaining it.

As discussed above, travel information may be displayed in any number of ways. For example, travel information may be displayed on a map, or as a list view (e.g., enumerating the results ordered by relevance, price, geography, etc.) or a combination thereof. Any number of techniques may be used to assist in user-friendly display of travel information. For example, offers displayed on the map may show the lowest price and be aggregated to one price bubble with other offers, for a geographic area and zoom level, to avoid clutter. The displayed price, for example the lowest price, can be clicked to display all relevant options represented by that bubble, or as the user zooms in to a new level, the different offers may be displayed separately as screen space permits, while maintaining a sensible presentation.

Presentation of travel information may update interactively as the user modifies one or more criteria, or may update only after the user has selected a particular set of criteria. Changing one or more criteria may cause some embodiments of an exploration tool to automatically zoom in to the relevant geographic area. Some embodiments may display the flight paths from an origin/departure location to destinations that meet the given criteria.

Any of the techniques described in the foregoing may be used alone or in any combination, including combinations not specifically described and/or illustrated.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

Components of data-entry systems described herein may be implemented using a single computer or its functionality may be distributed across multiple computers or servers. In distributed settings, communication among system components/modules/interfaces may be realized in any suitable manner (e.g., wired, wireless, network-based connections) as the present invention is not limited in this respect.

It should be appreciated that a computer may be embodied in any of numerous forms, such as a rack-mounted computer, a desktop computer, a laptop computer, or a tablet computer. Additionally, a computer may be embodied in any device with suitable processing capabilities, including a Personal Digital Assistant (PDA), a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output, and speakers or other sound generating devices for audible presentation of output. Examples of input devices that may be used for a user interface include keyboards, microphones, and pointing devices, such as mice, touch pads, and digitizing tablets.

Such computers may be interconnected by one or more networks in any suitable form, including a local area network (LAN) or a wide area network (WAN), such as an enterprise network, an intelligent network (IN) or the Internet. Such networks may be based on any suitable technology and may operate according to any suitable protocol and may include wireless networks, wired networks, and/or fiber optic networks.

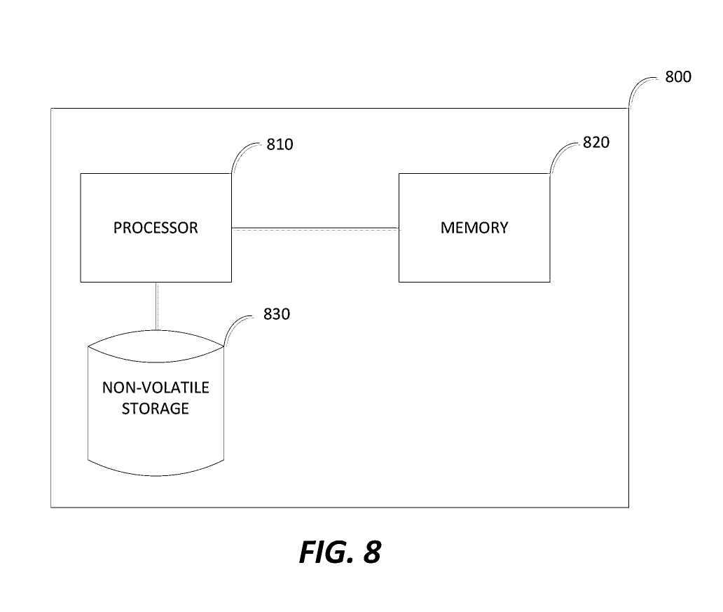

An illustrative implementation of a computer system 800 that may be used in connection with any of the embodiments of the invention described herein is shown in FIG. 8. The computer system 800 may be used as the or one of the computer system comprising the flight search service computer system, user device and/or flight information resources, and may include one or more processors 810 and one or more non-transitory computer-readable storage media (e.g., memory 820 and/or one or more non-volatile storage media 830). The processor 810 may control writing data to and reading data from the memory 820 and the non-volatile storage device 830 in any suitable manner, as the aspects of the invention described herein are not limited in this respect. To perform any of the functionality described herein, the processor 810 may execute one or more instructions stored in one or more computer-readable storage media (e.g., the memory 820), which may serve as non-transitory computer-readable storage media storing instructions for execution by the processor 810.

The various methods or processes, techniques and/or method outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one computer readable storage medium (e.g., a computer memory, one or more floppy discs, hard discs, compact discs, optical discs, magnetic tapes, flash memories, circuit configurations in Field Programmable Gate Arrays, cache, or other semiconductor devices capable of storing data, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above. The term computer readable storage medium is used herein to describe any tangible medium capable of storing data, such as the example media mentioned above, but excludes propagating signals and carrier waves, and the term non-transitory computer readable storage medium is co-extensive in this respect.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. At least one computer readable storage medium storing instructions that, when executed by at least one computer, perform a method comprising:
receiving at least one criterion from a user indicating one or more travel preferences, the at least one criterion not including a specific destination;
obtaining travel results for a plurality of destinations, each of the travel results meeting the at least one criterion; and
providing the travel results for display to the user.

2. The at least one computer readable medium of claim 1, wherein the travel results include at least one flight result for each of plurality of destinations.

3. The at least one computer readable medium of claim 1, wherein the travel results include hotel results for at least one of the plurality of destinations.

4. The at least one computer readable medium of claim 1, wherein the at least one criterion includes a departure city.

5. The at least one computer readable medium of claim 4, wherein the at least one criterion includes a maximum price, a maximum number of stops for a flight, a maximum flight time and/or a timeframe for departure.

6. The at least one computer readable medium of claim 4, wherein the at least one criterion comprises at least one characteristic about a potential destination.

7. The at least one computer readable medium of claim 6, wherein the at least one characteristic includes at least one indication of weather, geography and/or activities available at the potential destination.

8. The at least one computer readable medium of claim 2, further comprising presenting at least some of the travel results on a map by indicating on the map at least some of the plurality of destinations available to the user that meet the at least one criterion.

9. The at least one computer readable medium of claim 8, wherein presenting the at least some travel results includes presenting a flight price on the map in association with at least some of the plurality of destinations.

10. The at least one computer readable medium of claim 9, wherein the at least one criterion includes a timeframe over which flights are searched, and wherein presenting the flight price on the map includes displaying a lowest fare found over the specified timeframe for each of the at least some of the plurality of destinations.

11. The at least one computer readable medium of claim 10, further comprising:
receiving an indication from the user that the user is interested in a flight presented to the user; and
navigating to an itinerary for which the lowest fare was found.

12. The at least one computer readable medium of claim 9, further comprising:
receiving an indication from the user that the user is interested in a flight presented to the user; and
providing the user with the ability to book the flight.

13. A computer system comprising at least one computer storing a software implemented exploration tool that, when processed by the at least one computer, performs a method comprising:
providing at least one first interface for display to a user, the at least one first interface allowing the user to provide criteria regarding a trip;
receiving, via the at least one first interface, at least one criterion from the user indicating one or more travel preferences, the at least one criterion not including a specific destination;
obtaining travel results for a plurality of destinations, each of the travel results meeting the at least one criterion; and
providing the travel results for display to the user.

14. The computer system of claim 13, wherein the travel results include at least one flight result for each of plurality of destinations.

15. The computer system of claim 13, wherein the travel results include hotel results for at least one of the plurality of destinations.

16. The computer system of claim 13, wherein the at least one first interface includes a first control that allows a user to specify a departure city.

17. The computer system of claim 16, wherein the at least one first interface includes a control that allows the user to specify a maximum price, a control that allows the user to specify a maximum number of stops for a flight, a control that allows a user to specify a maximum flight time and/or a control that allows the user to specify a timeframe for departure.

18. The computer system of claim 16, wherein the at least one first interface comprises at least one control that allows a user to specify at least one characteristic about a potential destination.

19. The computer system of claim 18, wherein the at least one control that allows a user to specify at least one characteristic includes a control that allows the user to specify a desired weather characteristic, a control that allows the user to specify at least one characteristic regarding geography and/or a control that allows the user to specify one or more desired activities.

20. The computer system of claim 14, further comprising presenting at least some of the travel results on a map by indicating on the map at least some of the plurality of destinations available to the user that meet the at least one criterion.

21. The computer system of claim 20, wherein presenting the at least some travel results includes presenting a flight price on the map in association with at least some of the plurality of destinations indicated on the map.

22. The computer system of claim 21, wherein the at least one criterion includes a timeframe over which flights are searched, and wherein presenting the flight price on the map includes displaying a lowest fare found over the specified timeframe for each of the at least some of the plurality of destinations.

23. The computer system of claim 22, further comprising:
receiving an indication from the user that the user is interested in a flight presented to the user; and
navigating to an itinerary for which the lowest fare was found.

24. The computer system of claim 21, further comprising:
providing at least one second interface that allows a user to obtain further detail on flights displayed on the map;
receiving, via the at least one second interface, an indication from the user that the user is interested in a flight displayed on a map; and
providing at least one third interface that allows the user to book the flight.

25. A system comprising:
at least one storage medium for storing a flight cache comprising a plurality of flight results;
at least one processor capable of accessing the at least one storage medium to access the flight cache, the at least one processor configured to:
receive at least one criterion from the user indicating one or more travel preferences, the at least one criterion not including a specific destination;
obtain travel results for a plurality of destinations at least in part by querying the flight cache using the at least one criterion, wherein each of the travel results meet the at least one criterion; and
provide the travel results for display on at least one user computer.

26. The system of claim 25, wherein the travel results include at least one flight result for each of plurality of destinations.

27. The system of claim 25, wherein the travel results include hotel results for at least one of the plurality of destinations.

28. The system of claim 25, wherein the at least one criterion includes a departure city.

29. The system of claim 28, wherein the at least one criterion includes a maximum price, a maximum number of stops for a flight, a maximum flight time and/or a timeframe for departure.

30. The system of claim 28, wherein the at least one criterion comprises at least one characteristic about a potential destination.

31. The system of claim 30, wherein the at least one characteristic includes at least one indication of weather, geography and/or activities available at the potential destination.

32. The system of claim 26, wherein the at least one computer is configured to present at least some of the travel results on a map by indicating on the map at least some of the plurality of destinations available to the user that meet the at least one criterion.

33. The system of claim 32, wherein presenting the at least some travel results includes presenting a flight price on the map in association with at least some of the plurality of destinations.

34. The system of claim 33, wherein the at least one criterion includes a timeframe over which flights are searched, and wherein presenting the flight price on the map includes displaying a lowest fare found over the specified timeframe for each of the at least some of the plurality of destinations.

35. The system of claim 34, further comprising:
receiving an indication from the user that the user is interested in a flight presented to the user; and
navigating to an itinerary for which the lowest fare was found.

36. The system of claim 33, wherein the at least one computer is configured to:
receive an indication from the user that the user is interested in a flight presented to the user; and
provide the user with the ability to book the flight.
